(19) United States
(12) Patent Application Publication
(10) Pub. No.: US 2025/0308789 A1
(43) Pub. Date: Oct. 2, 2025

(54) CAPACITOR

(71) Applicant: Murata Manufacturing Co., Ltd., Nagaokakyo-shi (JP)

(72) Inventor: Daisuke YUASA, Nagaokakyo-shi (JP)

(21) Appl. No.: 19/238,663

(22) Filed: Jun. 16, 2025

Related U.S. Application Data
(63) Continuation of application No. PCT/JP2023/036362, filed on Oct. 5, 2023.

(30) Foreign Application Priority Data
Feb. 13, 2023 (JP) 2023-020175

(51) Int. Cl. H01G 4/228

(52) U.S. Cl. CPC H01G 4/228

(57) ABSTRACT

A capacitor that includes: an insulating substrate; first and second capacitance forming parts; a first external connection line, and a second external connection line. The second capacitance forming part is located on a side opposite to the first external connection line as viewed from the first capacitance forming part. The second capacitance forming part is electrically connected to the first external connection line with the first capacitance forming part interposed therebetween, and the first capacitance forming part is electrically connected to the second external connection line with the second capacitance forming part interposed therebetween, so that at least the first capacitance forming part and the second capacitance forming part are electrically connected in series between the first external connection line and the second external connection line.

### CROSS REFERENCE TO RELATED APPLICATIONS

The present application is a continuation of International application No. PCT/JP2023/036362, filed Oct. 5, 2023, which claims priority to Japanese Patent Application No. 2023-020175, filed Feb. 13, 2023, the entire contents of each of which are incorporated herein by reference.

### TECHNICAL FIELD

The present description relates to a capacitor including a capacitance forming part including a metal porous body, a dielectric film, and a conductive film.

### BACKGROUND ART

For example, US 2018/0277306 A (Patent Document 1) discloses a capacitor including a capacitance forming part provided by a metal porous body, a dielectric film covering the surface of the metal porous body, and a conductive film covering the dielectric film. In the capacitor, the metal porous body is made of a sintered body of metal particles, and the dielectric layer and the conductive film are both formed by an atomic layer deposition (ALD) method.

### SUMMARY OF THE DESCRIPTION

Here, since the capacitor disclosed in the above publication includes the single capacitance forming part, when electric field concentration occurs in the single capacitance forming part, there is a problem that the function as the capacitor is immediately impaired due to a short circuit.

Accordingly, the present description has been made to solve the problem mentioned above, and an object of the present description is to achieve improved reliability after mounting in a capacitor including a capacitance forming part including a metal porous body, a dielectric film, and a conductive film.

A capacitor according to the present description includes: an insulating substrate having a first main surface and a second main surface opposite to the first main surface; a first capacitance forming part facing the first main surface, the first capacitance forming part including: a first metal porous body having conductivity; a first dielectric film covering a surface of the first metal porous body; and a first conductive film covering the first dielectric film; and a second capacitance forming part facing the first main surface, the second capacitance forming part including: a second metal porous body having conductivity; a second dielectric film covering a surface of the second metal porous body; and a second conductive film covering the second dielectric film, wherein the first conductive film and the second conductive film are discontinuous with each other; a first external connection line; and a second external connection line, wherein the second capacitance forming part is located on a side opposite to the first external connection line as viewed from the first capacitance forming part, the second capacitance forming part is electrically connected to the first external connection line with the first capacitance forming part interposed therebetween, and when the first capacitance forming part is electrically connected to the second external connection line with the second capacitance forming part interposed therebetween, at least the first capacitance forming part and the second capacitance forming part are electrically connected in series between the first external connection line and the second external connection line.

According to the present description, the reliability after mounting is improved in the capacitor including the capacitance forming part including the metal porous body, the dielectric film, and the conductive film.

### BRIEF EXPLANATION OF THE DRAWINGS

FIG. 1(A) is a schematic front view and FIG. 1(B) is a schematic plan view of a capacitor according to a first embodiment.

FIG. 2 is a schematic sectional view of the capacitor illustrated in FIG. 1.

FIG. 3 is an enlarged schematic sectional view of the vicinity of a first main surface of an insulating substrate illustrated in FIG. 2.

FIG. 4 is an enlarged sectional view of a main section of a region IIII illustrated in FIG. 2.

FIG. 5 is an enlarged sectional view of a main section of a region V illustrated in FIG. 2.

FIG. 6 is a flowchart illustrating a method for manufacturing the capacitor according to the first embodiment.

FIG. 7 is a schematic sectional view illustrating a state after completing a step S4 of a manufacturing flow illustrated in FIG. 6.

FIG. 8 is a schematic sectional view for illustrating a step S5 of the manufacturing flow illustrated in FIG. 6.

FIG. 9 is a schematic sectional view for illustrating a step S6 of the manufacturing flow illustrated in FIG. 6.

FIG. 10 is a schematic sectional view for illustrating a step S7 of the manufacturing flow illustrated in FIG. 6.

FIG. 11 is a schematic sectional view for illustrating a step S8 of the manufacturing flow illustrated in FIG. 6.

FIG. 12 is a schematic sectional view for illustrating a step S9 of the manufacturing flow illustrated in FIG. 6.

FIG. 13 is a schematic sectional view for illustrating a step S10 of the manufacturing flow illustrated in FIG. 6.

FIG. 14 is a schematic sectional view for illustrating a step S11 of the manufacturing flow illustrated in FIG. 6.

FIG. 15 is a schematic sectional view for illustrating a step S12 of the manufacturing flow illustrated in FIG. 6.

FIG. 16 is a schematic sectional view for illustrating a step S13 of the manufacturing flow illustrated in FIG. 6.

FIG. 17 is a schematic sectional view for illustrating a step S14 of the manufacturing flow illustrated in FIG. 6.

FIG. 18 is a schematic sectional view for illustrating a step S15 of the manufacturing flow illustrated in FIG. 6.

FIG. 19 is a schematic sectional view for illustrating a step S16 of the manufacturing flow illustrated in FIG. 6.

FIG. 20 is a schematic sectional view for illustrating a step S17 of the manufacturing flow illustrated in FIG. 6.

FIG. 21 is a schematic sectional view for illustrating a step S18 of the manufacturing flow illustrated in FIG. 6.

FIG. 22 is a schematic sectional view for illustrating a step S19 of the manufacturing flow illustrated in FIG. 6.

FIG. 23 is a schematic sectional view for illustrating a step S20 of the manufacturing flow illustrated in FIG. 6.

FIG. 24 is a schematic sectional view of a capacitor according to a second embodiment.

FIG. 25 is a schematic sectional view of a capacitor according to a third embodiment.

FIG. 26 is a graph showing results of a verification test 1.

FIG. 27 is a graph showing results of a verification test 2.

### DETAILED DESCRIPTION OF THE PREFERRED EMBODIMENTS

Hereinafter, embodiments of the present description will be described in detail with reference to the drawings. It is to be noted that in the following embodiments, the same or common parts are denoted by the same reference numerals in the drawings, and description thereof will not be repeated. In addition, while the terms of “positive electrode” and “negative electrode” are used in the following embodiments for convenience of description, the electric polarities of capacitors according to the following embodiments are not to be considered uniquely determined by these terms, and the electric polarities are determined appropriately depending on the use environments of the capacitors.

### First Embodiment

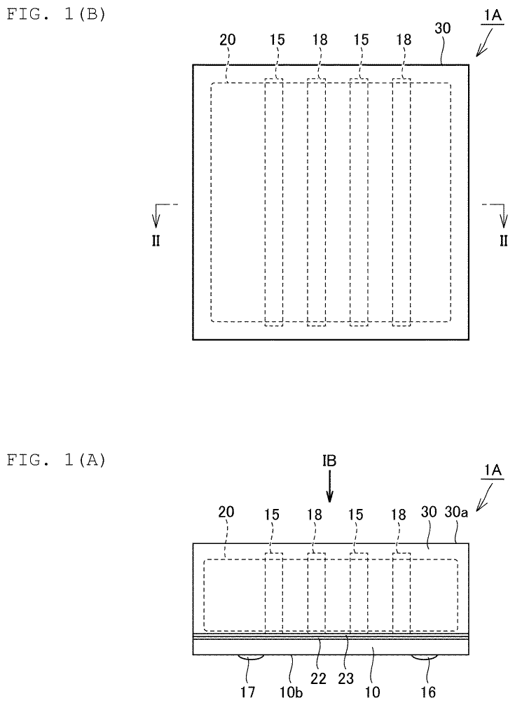

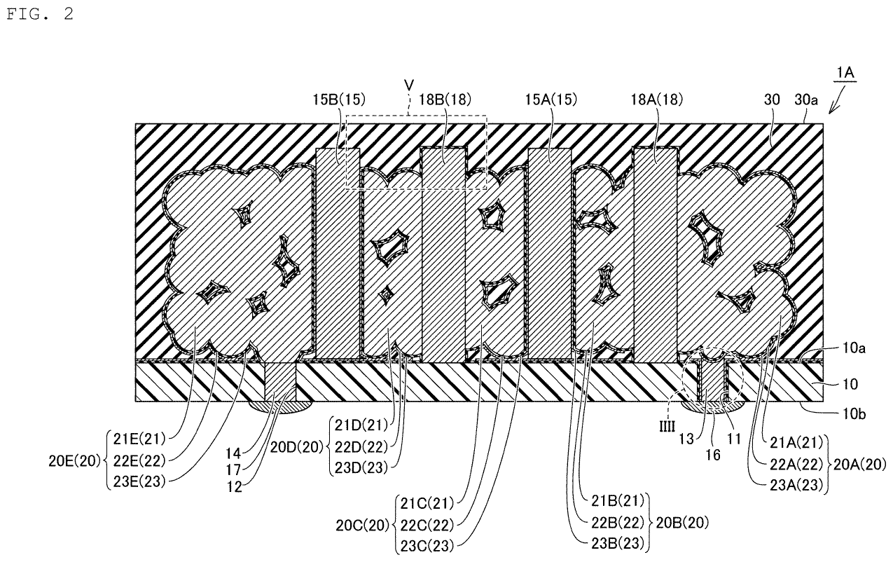

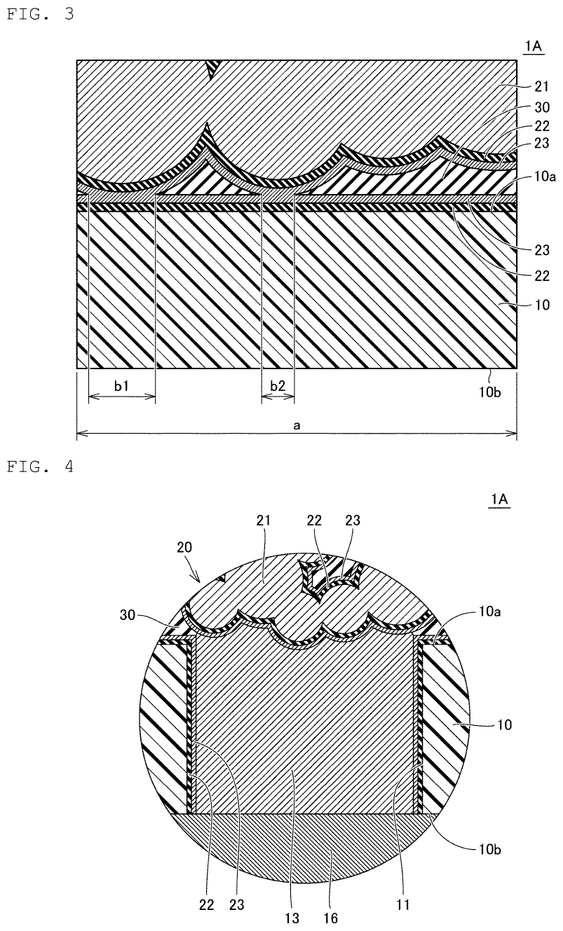

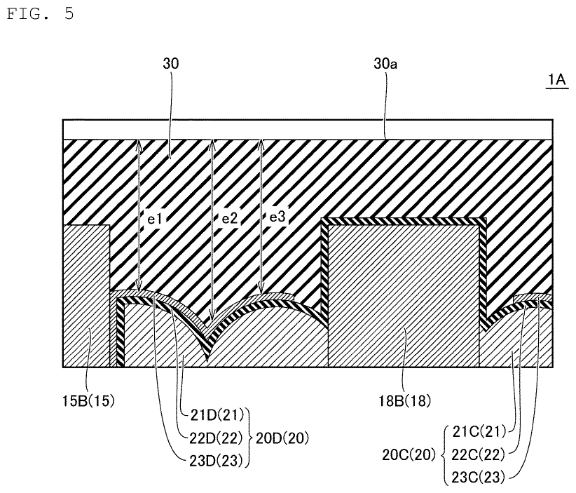

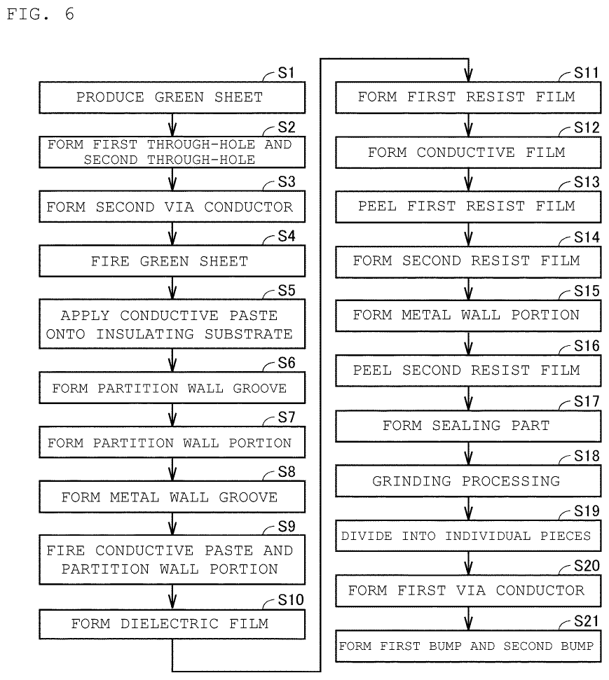

FIG. 1(A) is a schematic front view of a capacitor according to a first embodiment, and FIG. 1(B) is a schematic plan view of the capacitor viewed from the direction of an arrow IB illustrated in FIG. 1(A). FIG. 2 is a schematic sectional view of the capacitor taken along line II-II illustrated in FIG. 1(B). FIG. 3 is an enlarged schematic sectional view of the vicinity of a first main surface of an insulating substrate illustrated in FIG. 2. FIG. 4 is an enlarged sectional view of a main section of a region IIII illustrated in FIG. 2. FIG. 5 is an enlarged sectional view of a main section of a region V illustrated in FIG. 2. First, a configuration of a capacitor 1A according to the present embodiment will be described with reference to FIGS. 1 to 5.

As illustrated in FIGS. 1 and 2, the capacitor 1A has a flat and substantially rectangular parallelepiped outer shape, and is a so-called surface mount electronic component with a bottom surface configured as a mounting surface for a wiring board or the like. The capacitor 1A mainly includes an insulating substrate 10, a capacitance forming part 20, and a sealing part 30. In this regard, the capacitance forming part 20 is provided to face the insulating substrate 10. The capacitance forming part 20 is sealed by the insulating substrate 10 and the sealing part 30 provided on the insulating substrate 10 to be located inside the capacitor 1A.

The insulating substrate 10 is provided with a first via conductor 13, a second via conductor 14, a plurality of metal wall portions 15, a first bump 16, a second bump 17, and a plurality of partition wall portions 18. The first via conductor 13, the second via conductor 14, the first bump 16, and the second bump 17 constitute a pair of external connection lines as extended lines for electrically connecting the capacitance forming part 20 located inside the capacitor 1A to an external circuit. The pair of external connection lines includes a first external connection line as a positive electrode and a second external connection line as a negative electrode.

The insulating substrate 10 is made of a flat plate-like member having a first main surface 10a and a second main surface 10b located on the side opposite to the first main surface 10a. As the insulating substrate 10, a substrate that has an electrical insulation property is preferably used, and a substrate containing an inorganic material as a main component can be suitably used. More specifically, as the insulating substrate 10, for example, a substrate containing, as a main material, any of Si, Al₂O₃, ZrO₂, BN, Si₃N₄, AlN, MgO, Mg₂SiO₄, BaTiO₃, SrTiO₃, and CaTiO₃ can be used.

The thickness and size of the insulating substrate 10 are not particularly limited, but it is preferable to use, for example, an alumina substrate that has a rectangular shape of 5 μm to 75 μm in thickness and of 500 μm to 2000 μm on a side in plan view.

The insulating substrate 10 is provided with a first through-hole 11, and the first through-hole 11 penetrates the insulating substrate 10 so as to reach the second main surface 10b from the first main surface 10a. The first through-hole 11 is filled with the first via conductor 13. The first via conductor 13 has, for example, a substantially columnar shape.

The insulating substrate 10 is provided with the second through-hole 12, and the second through-hole 12 penetrates the insulating substrate 10 so as to reach the second main surface 10b from the first main surface 10a. The second through-hole 12 is filled with the second via conductor 14. The second via conductor 14 has, for example, a substantially columnar shape.

The first via conductor 13 constitutes a part of the first external connection line described above. The second via conductor 14 constitutes a part of the second external connection line described above. More specifically, the first via conductor 13 and the second via conductor 14 respectively constitute the first external connection line and second external connection line that differ in polarity.

When viewed in a normal direction of the first main surface 10a of the insulating substrate 10, the first via conductor 13 and the second via conductor 14 are both provided in a region where the capacitance forming part 20 is disposed.

The first via conductors 13 and the second via conductors 14 can be made of various wiring materials, and are preferably made of a metal material that has a particularly high electrical conductivity. A material of the first via conductor 13 and a material of the second via conductor 14 can be, for example, a metal material containing as a main material any one of Ni, Ag, Cu, Au, Pt, Mo, and W. In this regard, the materials of the first via conductors 13 and second via conductors 14 can be appropriately changed depending on the environment for mounting the capacitor 1A according to the present embodiment, and the material of the first via conductors 13 are not necessarily the same as the material of the second via conductors 14. According to the present embodiment, the first via conductors 13 and second via conductors 14 made of Ni are used.

The axial lengths and the sizes of the first via conductor 13 and the second via conductor 14 are not particularly limited, and are appropriately set according to the thickness and the size of the insulating substrate 10. In this regard, the axial lengths of the first via conductors 13 and the second via conductors 14 are preferably, for example, 5 μm to 75 μm, and the diameters thereof are preferably, for example, 15 μm to 150 μm. In the present embodiment, a conductor made of Ni having an axial length of 75 μm and a diameter of 150 μm is used as the first via conductor 13 and the second via conductor 14. A distance between the first via conductor 13 and the second via conductor 14 is 150 μm.

The first bump 16 is provided on the second main surface 10b of the insulating substrate 10 so as to cover the first via conductor 13. The first bump 16 serves as a joining material for mounting the capacitor 1A as a surface mount electronic component on a wiring board or the like and electrically connecting the capacitance forming part 20 of the capacitor 1A to an external circuit, and is provided to protrude from the second main surface 10b of the insulating substrate 10. The shape of the first bump 16 is substantially hemispherical.

The second bump 17 is provided on the second main surface 10b of the insulating substrate 10 so as to cover the second via conductor 14. The second bump 17 serves as a joining material for mounting the capacitor 1A as a surface mount electronic component on a wiring board or the like and electrically connecting the capacitance forming part 20 of the capacitor 1A to an external circuit, and is provided to protrude from the second main surface 10b of the insulating substrate 10. The shape of the second bump 17 is substantially hemispherical.

The first bump 16 constitutes a part of the first external connection line described above. The second bump 17 constitutes a part of the second external connection line described above. That is, the first bump 16 and the second bump 17 respectively constitute the first external connection line and the second external connection line that differ in polarity.

The first bumps 16 and the second bumps 17 can be made of various wiring materials, and are preferably made of a metal material that as a particularly high electrical conductivity. The material of the first bumps 16 and the material of the second bumps 17 can be, for example, a metal material containing, as a main material, any of Ni, Ag, Cu, Au, and Sn. According to the present embodiment, the first bumps 16 and the second bumps 17 made of Au are used.

The sizes of the first bumps 16 and second bumps 17 are not to be considered particularly limited, and are appropriately set depending on the sizes of the first via conductors 13 and second via conductors 14.

As described above, the first external connection line as the positive electrode of the pair of external connection lines is constituted by the first via conductor 13 and the first bump 16, and the second external connection line as the negative electrode of the pair of external connection lines is constituted by the second via conductor 14 and the second bump 17.

The insulating substrate 10 is provided with the plurality of metal wall portions 15 erected from the first main surface 10a toward the capacitance forming part 20. When viewed in the normal direction of the first main surface 10a, all of the plurality of metal wall portions 15 are located between the first external connection line and the second external connection line.

Hereinafter, a horizontal direction in FIG. 2 is referred to as a first direction, a vertical direction in FIG. 2 is referred to as a second direction, and a direction orthogonal to both the first direction and the second direction and orthogonal to the paper surface in FIG. 2 is referred to as a third direction. In the present embodiment, the first direction coincides with a direction connecting the first external connection line and the second external connection line, and the second direction coincides with a direction parallel to the normal direction of the first main surface 10a.

The plurality of metal wall portions 15 extend along both the second direction and the third direction. In the present embodiment, the two metal wall portions 15 extend linearly along both the second direction and the third direction.

The metal wall portion 15 does not necessarily extend linearly along the second direction. That is, the metal wall portion 15 may be erected from the first main surface 10a in a direction inclined to an appreciable extent with respect to the second direction. Furthermore, the metal wall portion 15 does not necessarily extend linearly along the third direction. That is, as long as the capacitance forming part 20 can be partitioned into a portion located on the first external connection line side and a portion located on the second external connection line side relative thereto, the metal wall portion 15 may extend in, for example, a bent shape or a curved shape.

A dimension (thickness) of the metal wall portion 15 in the first direction is preferably, for example, 5 μm to 150 μm, and more preferably 5 μm to 75 μm. As a result, warpage that may occur in the insulating substrate 10 described later can be effectively suppressed.

The dimension (height) of the metal wall portion 15 in the second direction is preferably larger than the dimension (height) of the capacitance forming part 20 in the same direction, and the dimension (width) of the metal wall portion 15 in the third direction is preferably larger than the dimension (width) of the capacitance forming part 20 in the same direction. This also makes it possible to effectively suppress warpage that may occur in the insulating substrate 10.

The material of the metal wall portion 15 can be, for example, a metal material mainly containing any of Ni, Cu, Ru, Al, W, Ti, Ag, Au, Ta, and Nb. In addition, the metal wall portion 15 may include an alloy material containing, as main components, two or more selected from these metal materials. According to the present embodiment, the metal wall portion 15 made of Cu is used.

The insulating substrate 10 is further provided with the plurality of partition wall portions 18 erected from the first main surface 10a toward the capacitance forming part 20. When viewed in the normal direction of the first main surface 10a, all of the plurality of partition wall portions 18 are located between the first external connection line and the second external connection line.

The plurality of partition wall portions 18 extend along both the second direction and the third direction. In the present embodiment, the two partition wall portions 18 extend linearly along both the second direction and the third direction.

By partitioning the capacitance forming part 20 by the partition wall portion 18 configured as described above, the capacitance forming part 20 includes a portion located on the first external connection line side and a portion located on the second external connection line side with respect to the first external connection line side, whereby a withstand voltage of the capacitor 1A can be improved, and details thereof will be described later.

The partition wall portion 18 does not necessarily extend linearly along the second direction. That is, the partition wall portion 18 may be erected from the first main surface 10a in a direction inclined to an appreciable extent with respect to the second direction. The partition wall portion 18 does not necessarily extend linearly along the third direction. That is, as long as the capacitance forming part 20 can be partitioned into a portion located on the first external connection line side and a portion located on the second external connection line side relative thereto, the partition wall portion 18 may extend in, for example, a bent shape or a curved shape.

A dimension (thickness) of the partition wall portion 18 in the first direction is preferably, for example, 5 μm to 150 μm, and more preferably 5 μm to 75 μm. As a result, it is possible not only to reliably prevent conductive films 23 of each of a pair of the capacitance forming parts partitioned by the partition wall portion 18 from being unintentionally continuously formed, but also to effectively suppress warpage that may occur in the insulating substrate 10.

The dimension (height) of the partition wall portion 18 in the second direction is preferably larger than the dimension (height) of the capacitance forming part 20 in the same direction, and the dimension (width) of the partition wall portion 18 in the third direction is preferably larger than the dimension (width) of the capacitance forming part 20 in the same direction. This also makes it possible not only to reliably prevent the conductive films 23 of each of the pair of capacitance forming parts partitioned by the partition wall portion 18 from being unintentionally continuously formed, but also to effectively suppress warpage that may occur in the insulating substrate 10.

The partition wall portion 18 preferably includes the same material as at least a part of the material included in the metal porous body 21, which will be described later. The material of the partition wall portion 18 can be a metal material containing, for example, any of Ni, Cu, Ru, Al, W, Ti, Ag, Au, Ta, and Nb as a main material. In addition, the partition wall portion 18 may be made of an alloy material containing, as main components, two or more selected from these metal materials. According to the present embodiment, the partition wall portion 18 made of Ni is used.

Here, as described above, the capacitor 1A according to the present embodiment includes the two metal wall portions 15 and the two partition wall portions 18. In the following description, of the two metal wall portions 15, one located on the first external connection line side is referred to as a metal wall portion 15A, and one located on the second external connection line side with respect to the metal wall portion 15A is referred to as a metal wall portion 15B. Similarly, of the two partition wall portions 18, one located on the first external connection line side is referred to as a partition wall portion 18A, and one located on the second external connection line side with respect to the partition wall portion 18A is referred to as a partition wall portion 18B.

The two metal wall portions 15 and the two partition wall portions 18 are arranged in the order of the metal wall portion 15A, the partition wall portion 18A, the metal wall portion 15B, and the partition wall portion 18B from the first external connection line side toward the second external connection line side (that is, from the right side to the left side in FIG. 2). With this configuration, the capacitance forming part 20 can be divided into a plurality of capacitance forming parts, which will be described in detail later.

As illustrated in FIG. 2, the capacitance forming part 20 is provided so as to face the first main surface 10a of the insulating substrate 10, and includes the conductive metal porous body 21 with a plurality of fine pores therein, the dielectric film 22 covering the surface of the metal porous body 21, and the conductive film 23 further covering the surface of the dielectric film 22.

It is to be noted that while the capacitance forming part 20 is provided so as to face the insulating substrate 10, the capacitance forming part 20 is not substantially directly joined to the insulating substrate 10, or if directly joined, is only slightly joined thereto. In this regard, the state in which the capacitance forming part 20 is only slightly joined to the insulating substrate 10 means a state in which a part of the capacitance forming part 20 is joined to the insulating substrate 10 at a predetermined ratio or less. More specifically, the state in which the capacitance forming part 20 is only slightly joined to the insulating substrate 10 means that, as illustrated in FIG. 3, when an arbitrary region on the first main surface 10a of the insulating substrate 10 is viewed in a section orthogonal to the extending direction of the first main surface 10a of the insulating substrate 10, the sum (that is, the line segment length b1+b2 in the example illustrated in FIG. 3) of line segment lengths parallel to the first main surface 10a, of a part where the metal porous body 21 is joined directly to the insulating substrate 10 or indirectly thereto with the dielectric film 22 or the conductive film 23 interposed therebetween in the arbitrary region, is 30% or less of the total line segment length (that is, the line segment length a in the example illustrated in FIG. 3) of the first main surface 10a in the arbitrary region.

At least a part of the plurality of fine pores provided inside the metal porous body 21 is not closed by the metal porous body itself, and preferably, most or all of the plurality of fine pores provided inside the metal porous body are not closed by the metal porous body itself. Such a metal porous body is made of, for example, a sintered body of metal particles.

The metal porous body 21 can be made of various conductive metal materials, and is preferably made of a metal material containing, as a main material, any of Ni, Mo, W, Al, Ti, Ta, Nb, Cu, Pt, Au, and Ag. In addition, the metal porous body 21 may be made of an alloy material containing, as main components, two or more selected from these metal materials. According to the present embodiment, the metal porous body 21 made of Ni is used.

The thickness and size of the metal porous body 21 are not to be considered particularly limited, and in particular, the size is appropriately set depending on the size of the insulating substrate 10. In the present embodiment, as the metal porous body 21, one having a 1000 μm square and a thickness of 200 μm in a state before the capacitance forming part 20 is partitioned as described later is used.

In this regard, as described above, the metal porous body 21 is preferably made of a sintered body of metal particles. In that case, metal particles that have various shapes such as a spherical shape, an elliptical spherical shape, a flat shape, a plate shape, and a needle shape can be used. In addition, the particle sizes of the metal particles are not to be considered particularly limited, but the average particle size thereof is preferably 600 nm or less, more preferably 20 nm to 500 nm.

Here, as illustrated in FIG. 2, a part of the metal porous body 21 is joined to the second via conductor 14. Therefore, the second external connection line as the negative electrode described above is connected to the capacitance forming part 20 with the second via conductor 14 interposed therebetween.

The dielectric film 22 covers the surface of the metal porous body 21 as described above. More specifically, the dielectric film 22 covers not only the surface of the metal porous body 21 of a portion located on the outermost side of the capacitance forming part 20 but also a surface defined by the above-described fine pores which are not closed by the metal porous body itself out of the surface of the metal porous body 21 of a portion located inside the capacitance forming part 20. The dielectric film 22 also covers the surface of the partition wall portion 18 at a portion not joined to the metal porous body 21.

The dielectric film 22 can be made of various insulating materials, and can be made of, for example, a metal oxide such as AlOₓ, SiOₓ, HfOₓ, TiOₓ, TaOₓ, ZrOₓ, SiAlOₓ, HfAlOₓ, ZrAlOₓ, AlTiOₓ, SrTiOₓ, HfSiOₓ, ZrSiOₓ, TiZrOₓ, TiZrOₓ, TiZrWOₓ, SrTiOₓ, BaTiOₓ, PbTiOₓ, BaSrTiOₓ, and BaCaTiOₓ, a metal nitride such as AlNₓ, SiNₓ, and AlScNₓ, and a metal oxynitride such as AlOₓN_{y}, SiOₓN_{y}, HfOₓN_{y}, and SiCₓO_{y}N_{z}. Among the materials, the dielectric film 22 is preferably made of any of AlOₓ (for example, Al₂O₃), SiOₓ (for example, SiO₂), HfOₓ, TiOₓ, SiAlOₓ, HfAlOₓ, ZrAlOₓ, HfSiOₓ, and ZrSiOₓ. It is to be noted that the chemical formulas mentioned above are merely intended to represent the constitutions of the materials, and are not intended to limit the composition. More specifically, x, y, and z attached to O and N may be any value larger than 0, and the abundance ratios of the respective elements including the metal elements are arbitrary. In addition, the dielectric film 22 may be made of a laminated film including a plurality of dielectric layers that differ in material. According to the present embodiment, the dielectric film 22 made of AlSiO nm is used.

The dielectric film 22 can be preferably formed by a gas phase method, for example, a vacuum deposition method, a chemical vapor deposition (CVD: Chemical Vapor Deposition) method, a sputtering method, an atomic layer deposition (ALD) method, a pulsed laser deposition (PLD: Pulsed Laser Deposition) method, or the like, or a method of using a supercritical fluid, and is particularly preferably formed by the ALD method.

The thickness of the dielectric film 22 is not particularly limited, but is preferably 3 nm to 100 nm, and more preferably 5 nm to 50 nm. When the thickness of the dielectric film 22 is 3 nm or more, the withstand voltage of the capacitor 1A can be improved.

The conductive film 23 covers the surface of the dielectric film 22 as described above. More specifically, the conductive film 23 covers not only the surface of the dielectric film 22 of the portion located on the outermost side of the capacitance forming part 20 but also the surface of the dielectric film 22 of the portion located inside the capacitance forming part 20.

Here, the conductive film 23 does not cover the surface of the dielectric film 22 in a portion covering the partition wall portion 18 and a portion located in the vicinity thereof. Thus, the conductive film 23 in a portion on the first external connection line side as viewed from the partition wall portion 18 and the conductive film 23 in a portion on the second external connection line side as viewed from the partition wall portion 18 are configured to be discontinuous with each other. With such a configuration, the withstand voltage of the capacitor 1A can be improved, and the details thereof will be described later.

The conductive film 23 can be made of various conductive materials, and can be made of a metal material containing, as a main material, any of Ni, Cu, Ru, Al, W, Ti, Ag, Au, Zn, Ta, and Nb, an alloy material containing, as main components, two or more selected from these metal materials, a metal nitride such as TiN, TiAlN, TiSiN, TaN, NbN, and WN, a metal oxynitride such as TiON or TiAlON, a conductive polymer such as poly(3,4-ethylenedioxythiophene) (PEDOT), polypyrrole, and polyaniline, or a conductive oxide film such as RuO₂, ZnO, (Zn, Al) O, and NiO. Among these materials, the conductive film 23 is preferably made of TiN or an oxide semiconductor such as TION, ZnO, and RuO. According to the present embodiment, the conductive film 23 made of TiN is used.

The conductive film 23 can be preferably formed by a CVD method, an ALD method, a PLD method, a plating method, a bias sputtering method, a sol-gel method, a method of using conductive polymer filling, or a method of using a supercritical fluid, and is particularly preferably formed by an ALD method. In addition, the conductive film 23 may be made of a laminated film including a plurality of dielectric layers that differ in material. In that case, after film formation is performed by an ALD method, film formation can be performed by another method.

The thickness of the conductive film 23 is not particularly limited, but is preferably 3 nm or more, and more preferably 10 nm or more.

In this regard, the dielectric film 22 and conductive film 23 described above cover not only the surface of the metal porous body 21 but also a predetermined part of the insulating substrate 10 on the side with the first main surface 10a. Furthermore, as illustrated in FIG. 4, the dielectric film 22 and the conductive film 23 also cover the surface of the insulating substrate 10 in sections that define the first through-holes 11 provided in the insulating substrate 10. More specifically, at a boundary portion between the first via conductor 13 and a substrate of the insulating substrate 10, the insulating substrate 10 is covered with the dielectric film 22, the dielectric film 22 is covered with the conductive film 23, and the conductive film 23 is covered with the first via conductor 13. In addition, the end of the first via conductor 13 on the side with the first main surface 10a is covered with the capacitance forming part 20.

Thus, the conductive film 23 is joined to the first via conductor 13. Thus, the first external connection line as the positive electrode described above is connected to the capacitance forming part 20 with the first via conductor 13 interposed therebetween.

As illustrated in FIG. 2, the sealing part 30 is provided on the first main surface 10a of the insulating substrate 10 to seal together with the insulating substrate 10, the capacitance forming part 20, and define an outer surface 30a located on the side opposite to the side with the insulating substrate 10 as viewed from the capacitance forming part 20. More specifically, the sealing part 30 is located so as to cover the upper side, lateral side, and lower side of the capacitance forming part 20 provided so as to face the first main surface 10a of the insulating substrate 10, and is further located within holes inside the capacitance forming part 20.

The sealing part 30 can be made of various insulating materials, and is preferably made of an insulating material that is excellent in weather resistance. The material of the sealing part 30 can be, for example, a resin material such as a polyimide resin, a polybenzoxazole resin, a polyethylene terephthalate resin, a benzocyclobutene resin, or an epoxy resin. In addition, the resin material can contain various additives, and may contain therein an SiO₂ filler, an Al₂O₃ filler, or the like, for example, for adjusting the thermal expansion coefficient. According to the present embodiment, the sealing part 30 made of an epoxy resin is used.

Further, when it is difficult to secure moisture resistance only with the sealing part 30, a moisture-resistant protective film may be formed between the capacitance forming part 20 and the sealing part 30. For example, before forming the sealing part 30, the moisture-resistant protective film can be formed by providing an inorganic insulator made of SiN, SiO₂, Al₂O₃, HfO₂, ZrO₂, or the like by a CVD method, an ALD method, or the like so as to cover the capacitance forming part 20, or by providing an organic insulator with water repellency, such as a fluorine-based resin or a silane coupling agent resin, so as to cover the capacitance forming part 20. In this regard, the moisture-resistant protective film does not necessarily have to be formed inside of the capacitance forming part 20, and it is sufficient for the film to be formed to cover only the outer surface.

The sealing part 30 can be formed by various coating methods, and for example, a method using a vacuum laminator, a method using an air dispenser, a method using a jet dispenser, a screen printing method, a vacuum printing method, an electrostatic coating method, an inkjet method, a photolithography method, or the like can be used.

The thickness and size of the sealing part 30 are not to be considered particularly limited, and the size is appropriately set depending on the size of the insulating substrate 10. In this regard, the thickness of the sealing part 30 is preferably, for example, 5 μm to 50 μm, and the size is preferably, for example, such a size that covers the entire surface of the first main surface 10a of the insulating substrate 10.

The thickness of the sealing part 30 described above is measured, for example, by observing a section orthogonal to the extending direction of the first main surface 10a of the insulating substrate 10 with the use of an optical microscope.

Specifically, when the longitudinal direction of the capacitor 1A in a plan view of the capacitor 1A, the lateral direction thereof, and the thickness direction (that is, the normal direction of the first main surface 10a) of the capacitor 1A are denoted respectively by Lx, Ly, and Lz, first, the capacitor 1A is subjected to a polishing treatment so as to expose an Lx-Lz section of a part of the capacitor 1A located at the center in the Ly direction. The polishing treatment is performed such that the exposed section is located within an error range of +100 μm in the Ly direction with the central position as a reference.

Next, a part in the vicinity of the outer surface 30a in the exposed section is observed at a magnification of 1000 times with the use of an optical microscope. The observation range of the section in the Lx direction is a range of +50 μm with center position of the section in the Lx direction as a reference, and is a range in which neither the metal wall portion 15 nor the partition wall portion 18 is provided.

Next, in the observation range of the section, the thickness of the sealing part 30 in the Lz direction is measured at ten sites at equal intervals in the Lx direction, and the average value thereof is calculated. The average value calculated in this manner is the thickness of the sealing part 30. In this regard, in FIG. 5, three of the thicknesses of the sealing part 30 in the Lz direction, measured at the ten sites, are illustrated as line segment lengths e1, e2, and e3.

With the foregoing configuration, in the capacitor 1A according to the present embodiment, the capacitance forming part 20 including the metal porous body 21, the dielectric film 22, and the conductive film 23 is sealed by the insulating substrate 10 and the sealing part 30, and an electrical extension from the capacitance forming part 20 is achieved by the pair of external connection lines.

Here, as illustrated in FIG. 2, in the capacitor 1A according to the present embodiment, the capacitance forming part 20 is partitioned into the plurality of capacitance forming parts by the plurality of metal wall portions 15 and the plurality of partition wall portions 18, and these plurality of capacitance forming parts are arranged side by side from the first external connection line side toward the second external connection line side (that is, from the right side to the left side in FIG. 2).

The capacitance forming part 20 in the present embodiment is divided into five parts, and for convenience of description, these five capacitance forming parts are referred to as a capacitance forming part 20A, a capacitance forming part 20B, a capacitance forming part 20C, a capacitance forming part 20D, and a capacitance forming part 20E in order from the closest to the first external connection line.

In the present embodiment, the metal porous body 21, the dielectric film 22, and the conductive film 23 of a portion that defines the capacitance forming part 20A are referred to as a metal porous body 21A, a dielectric film 22A, and a conductive film 23A, respectively. Similarly, the metal porous body 21, the dielectric film 22, and the conductive film 23 of a portion that defines the capacitance forming part 20B are referred to as a metal porous body 21B, a dielectric film 22B, and a conductive film 23B, respectively, the metal porous body 21, the dielectric film 22, and the conductive film 23 of a portion that defines the capacitance forming part 20C are referred to as a metal porous body 21C, a dielectric film 22C, and a conductive film 23C, respectively, the metal porous body 21, the dielectric film 22, and the conductive film 23 of a portion that defines the capacitance forming part 20D are referred to as a metal porous body 21D, a dielectric film 22D, and a conductive film 23D, respectively, and the metal porous body 21, the dielectric film 22, and the conductive film 23 of a portion that defines the capacitance forming part 20E are referred to as a metal porous body 21E, a dielectric film 22E, and a conductive film 23E, respectively.

In the present embodiment, the capacitance forming part 20A corresponds to a first capacitance forming part, and the capacitance forming parts 20B to 20E correspond to a second capacitance forming part. Thus, the metal porous body 21A corresponds to a first metal porous body, the dielectric film 22A corresponds to a first dielectric film, the conductive film 23A corresponds to a first conductive film, the metal porous bodies 21B to 21E correspond to a second metal porous body, the dielectric films 22B to 22E correspond to a second dielectric film, and the conductive films 23B to 23E correspond to a second conductive film.

In the present embodiment, the capacitance forming part 20B corresponds to a third capacitance forming part, and the capacitance forming parts 20C to 20E correspond to a fourth capacitance forming part. Thus, the metal porous body 21B corresponds to a third metal porous body, the dielectric film 22B corresponds to a third dielectric film, the conductive film 23B corresponds to a third conductive film, the metal porous bodies 21C to 21E correspond to a fourth metal porous body, the dielectric films 22C to 22E correspond to a fourth dielectric film, and the conductive films 23C to 23E correspond to a fourth conductive film.

In addition, in the present embodiment, the capacitance forming part 20C corresponds to a fifth capacitance forming part, and the capacitance forming parts 20D and 20E correspond to a sixth capacitance forming part. Thus, the metal porous body 21C corresponds to a fifth metal porous body, the dielectric film 22C corresponds to a fifth dielectric film, the conductive film 23C corresponds to a fifth conductive film, the metal porous bodies 21D and 21E correspond to a sixth metal porous body, the dielectric films 22D and 22E correspond to a sixth dielectric film, and the conductive films 23D and 23E correspond to a sixth conductive film.

In the present embodiment, the capacitance forming part 20D corresponds to a seventh capacitance forming part, and the capacitance forming part 20E corresponds to an eighth capacitance forming part. Thus, the metal porous body 21D corresponds to a seventh metal porous body, the dielectric film 22D corresponds to a seventh dielectric film, the conductive film 23D corresponds to a seventh conductive film, the metal porous body 21E corresponds to an eighth metal porous body, the dielectric film 22E corresponds to an eighth dielectric film, and the conductive film 23E correspond to an eighth conductive film.

In addition, in the present embodiment, the metal wall portion 15A and the metal wall portion 15B correspond to the first metal wall portion and the second metal wall portion, respectively, and the partition wall portion 18A and the partition wall portion 18B correspond to the first partition wall portion and the second partition wall portion, respectively.

Hereinafter, the configuration of the plurality of capacitance forming parts 20A to 20E and a relationship between the plurality of capacitance forming parts 20A to 20E and the metal wall portion 15 and the partition wall portion 18 will be described in detail.

In the capacitor 1A according to the present embodiment, as illustrated in FIGS. 2 and 5, the conductive film 23 of the capacitance forming part 20 is configured to be discontinuous with the partition wall portion 18A and the vicinity thereof as a boundary. More specifically, the conductive film 23A of the capacitance forming part 20A, which is a portion on the first external connection line side as viewed from the partition wall portion 18A, and the conductive film 23B of the capacitance forming part 20B, which is a portion on the second external connection line side as viewed from the partition wall portion 18A and is a portion adjacent to the partition wall portion 18A, are configured to be discontinuous with each other. In other words, since the conductive film 23 includes the conductive film 23A and the conductive film 23B that are discontinuous with each other, the capacitance forming part 20 includes the capacitance forming part 20A defined by the conductive film 23A, the dielectric film 22A that is the dielectric film 22 of a portion corresponding to the conductive film 23A, and the metal porous body 21A that is the metal porous body 21 of a portion corresponding to the dielectric film 22A, and the capacitance forming part 20B defined by the conductive film 23B, the dielectric film 22B that is the dielectric film 22 of a portion corresponding to the conductive film 23B, and the metal porous body 21B that is the metal porous body 21 of a portion corresponding to the dielectric film 22B.

The conductive film 23A of the capacitance forming part 20A is joined to the first via conductor 13, and the metal porous body 21E of the capacitance forming part 20E is joined to the second via conductor 14.

The partition wall portion 18A partitions the metal porous bodies 21A to 21E into the metal porous body 21A and the metal porous bodies 21B to 21E, partitions the dielectric films 22A to 22E into the dielectric film 22A and the dielectric films 22B to 22E, and further partitions the conductive films 23A to 23E into the conductive film 23A and the conductive films 23B to 23E.

The partition wall portion 18A is not joined to the conductive film 23A and the conductive film 23B. On the other hand, the partition wall portion 18A is joined to the metal porous body 21A of the capacitance forming part 20A on a side surface on the first external connection line side, and is joined to the metal porous body 21B of the capacitance forming part 20B on a side surface on the second external connection line side.

With such a configuration, the capacitance forming parts 20B to 20E are electrically connected to the first external connection line with the capacitance forming part 20A interposed therebetween, and the capacitance forming part 20A is electrically connected to the second external connection line with the capacitance forming parts 20B to 20E interposed therebetween. As a result, the capacitance forming part 20A and the capacitance forming parts 20B to 20E are electrically connected in series between the first external connection line and the second external connection line with the partition wall portion 18A interposed therebetween.

In the capacitor 1A, since the metal wall portion 15A is provided on the insulating substrate 10, the capacitance forming parts 20B to 20E of the capacitance forming parts 20 are partitioned into the capacitance forming part 20B and the capacitance forming parts 20C and 20E, which are remaining portions thereof. The capacitance forming part 20B is located on the first external connection line side, and the capacitance forming parts 20C to 20E are located on the second external connection line side with respect to the capacitance forming part 20B.

Here, in the capacitor 1A, the metal wall portion 15A is joined to the conductive film 23B of the capacitance forming part 20B, and is not joined to the metal porous body 21B and the dielectric film 22B. The metal wall portion 15A is joined to the conductive film 23C of the capacitance forming part 20C which is a portion of the capacitance forming parts 20C to 20E adjacent to the metal wall portion 15A, and is not joined to the metal porous body 21C and the dielectric film 22C.

With such a configuration, the capacitance forming parts 20C to 20E are electrically connected to the first external connection line with the capacitance forming part 20B interposed therebetween, and the capacitance forming part 20B is electrically connected to the second external connection line with the capacitance forming parts 20C to 20E interposed therebetween. As a result, the capacitance forming part 20B and the capacitance forming parts 20C to 20E are electrically connected in series between the first external connection line and the second external connection line.

In addition, in the capacitor 1A, the conductive film 23 of a portion of the capacitance forming part 20 corresponding to the capacitance forming parts 20C to 20E is configured to be discontinuous with the partition wall portion 18B and the vicinity thereof as a boundary. More specifically, the conductive film 23C of the capacitance forming part 20C, which is a portion on the first external connection line side as viewed from the partition wall portion 18B, and the conductive film 23D of the capacitance forming part 20D, which is a portion on the second external connection line side as viewed from the partition wall portion 18B, are configured to be discontinuous with each other. In other words, since the conductive film 23 includes the conductive film 23C and the conductive film 23D that are discontinuous with each other, the capacitance forming part 20 includes the capacitance forming part 20C defined by the conductive film 23C, the dielectric film 22C that is the dielectric film 22 of a portion corresponding to the conductive film 23C, and the metal porous body 21C that is the metal porous body 21 of a portion corresponding to the dielectric film 22C, and the capacitance forming part 20D defined by the conductive film 23D, the dielectric film 22D that is the dielectric film 22 of a portion corresponding to the conductive film 23D, and the metal porous body 21D that is the metal porous body 21 of a portion corresponding to the dielectric film 22D.

The partition wall portion 18B partitions the metal porous bodies 21C to 21E into the metal porous body 21C and the metal porous bodies 21D and 21E, partitions the dielectric films 22C to 22E into the dielectric film 22C and the dielectric films 22D and 22E, and further partitions the conductive films 23C to 23E into the conductive film 23C and the conductive films 23D and 23E.

The partition wall portion 18B is not joined to the conductive film 23C and the conductive film 23D. On the other hand, the partition wall portion 18B is joined to the metal porous body 21C of the capacitance forming part 20C on the side surface on the first external connection line side, and is joined to the metal porous body 21D of the capacitance forming part 20D on the side surface on the second external connection line side.

With such a configuration, the capacitance forming parts 20D and 20E are electrically connected to the first external connection line with the capacitance forming part 20C interposed therebetween, and the capacitance forming part 20C is electrically connected to the second external connection line with the capacitance forming parts 20D and 20E interposed therebetween. As a result, the capacitance forming part 20C and the capacitance forming parts 20D and 20E are electrically connected in series between the first external connection line and the second external connection line with the partition wall portion 18B interposed therebetween.

In the capacitor 1A, since the metal wall portion 15B is provided on the insulating substrate 10, the capacitance forming parts 20D and 20E of the capacitance forming parts 20 are partitioned into the capacitance forming part 20D and the capacitance forming part 20E. The capacitance forming part 20D is located on the first external connection line side, and the capacitance forming part 20E is located on the second external connection line side with respect to the capacitance forming part 20D.

Here, in the capacitor 1A, the metal wall portion 15B is joined to the conductive film 23D of the capacitance forming part 20D, and is not joined to the metal porous body 21D and the dielectric film 22D. The metal wall portion 15B is joined to the conductive film 23E of the capacitance forming part 20E, and is not joined to the metal porous body 21E and the dielectric film 22E.

With such a configuration, the capacitance forming part 20E is electrically connected to the first external connection line with the capacitance forming part 20D interposed therebetween, and the capacitance forming part 20D is electrically connected to the second external connection line with the capacitance forming part 20E interposed therebetween. As a result, the capacitance forming part 20D and the capacitance forming part 20E are electrically connected in series between the first external connection line and the second external connection line.

With the above configuration, in the capacitor 1A according to the present embodiment, the capacitance forming part 20A, the capacitance forming part 20B, the capacitance forming part 20C, the capacitance forming part 20D, and the capacitance forming part 20E are electrically connected in series between the first external connection line and the second external connection line in this order.

In the present embodiment, as described above, the case where the five capacitance forming parts 20A to 20E are connected in series has been exemplified; however, the number of capacitance forming parts connected in series (that is, the number of partitions of the capacitance forming part 20) is not particularly limited to five as long as the number is plural, and may be two to four, or may be six or more. When the number of the capacitance forming parts connected in series is changed, the number of portions where another conductive film 23 to be added to the capacitor provided with a portion where the conductive film 23 is discontinuously formed is continuously formed and the number of the metal wall portions 15 may be appropriately changed. At this time, the portion where the conductive film 23 is discontinuously formed and the metal wall portion 15 need to be alternately arranged from the first external connection line side toward the second external connection line side.

In the capacitor 1A according to the present embodiment described above, the conductive film 23A and the conductive film 23B are formed so as to be discontinuous with each other, and the metal porous body 21A and the metal porous body 21B are joined to the partition wall portion 18A provided between the capacitance forming part 20A and the capacitance forming part 20B, so that the capacitance forming part 20A and the capacitance forming part 20B are partitioned from each other and electrically connected in series; however, in the capacitor 1A, the partition wall portion 18A is not necessarily provided. That is, when the metal porous body 21A and the metal porous body 21B are joined to each other without providing the partition wall portion 18A, if the conductive film 23A and the conductive film 23B are configured to be discontinuous with each other, it is possible to partition the capacitance forming part 20A and the capacitance forming part 20B from each other and electrically connect them in series as described above. The same applies to the relationship between the partition wall portion 18B and the capacitance forming parts 20C and 20D.

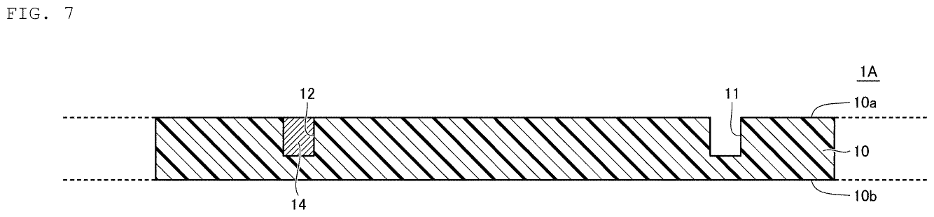

FIG. 6 is a flowchart illustrating a method for manufacturing the capacitor according to the present embodiment. FIGS. 7 to 23 are schematic sectional views for illustrating respective steps of the manufacturing flow illustrated in FIG. 6. Next, an example of a specific manufacturing method for manufacturing the capacitor 1A according to the present embodiment described above will be described with reference to FIGS. 6 to 23.

The method for manufacturing the capacitor 1A as described below is a method for simultaneously mass-producing a plurality of capacitors 1A by collectively performing treatments for processing up to a middle stage of the manufacturing process to produce an assembly of capacitors in process, thereafter dividing the assembly into individual pieces, and further applying treatments for processing to the individual pieces in process.

First, as illustrated in FIG. 6, in a step S1, a green sheet is produced. Specifically, an Al₂O₃ powder and glass powder are weighed, and the Al₂O₃ powder and the glass powder, an organic solvent such as toluene or ethanol, and a binder such as polyvinyl butyral are mixed. Thereafter, the mixture is formed into a sheet shape, thereby producing a green sheet as a base for the insulating substrate. It is to be noted that after the production of the green sheet, the green sheet is cut to prepare a plurality of green sheets.

Next, as illustrated in FIG. 6, in a step S2, first through-holes and second through-holes are formed in a part of the plurality of green sheets. Specifically, at predetermined positions of the green sheet, the first through-holes 11 to be filled later with a first via conductor that is a part of a positive electrode is provided, and the second through-holes 12 to be filled later with a second via conductor that is a part of a negative electrode is provided.

In this regard, a method for forming the first through-holes 11 and the second through-holes 12 is not to be considered particularly limited, but for example, the first through-hole 11 and the second through-hole 12 can be formed by irradiating the green sheet with laser light. In addition, the first through-holes 11 and the second through-holes 12 may also be formed by processing with a mechanical puncher used or sandblasting.

Next, as illustrated in FIG. 6, in a step S3, the second via conductor is formed in the green sheet with the first through-hole and the second through-hole formed. Specifically, a conductive paste is applied to the green sheet so as to embed the second through-holes 12. It is to be noted that in that regard, the first through-hole 11 is not filled with the conductive paste.

In this regard, the method for applying the conductive paste is not to be considered particularly limited, but for example, a screen printing method can be used.

Next, as illustrated in FIG. 6, in a step S4, the green sheet is fired. Specifically, the green sheet without the first through-holes, the second through-holes, or the like provided is stacked on the green sheet with the conductive paste applied thereto in the step S3, and the stacked green sheets are subjected to pressure bonding. Then, the laminate of the green sheets subjected to the pressure bonding is subjected to a degreasing treatment, and then the laminate of the green sheets subjected to the degreasing treatment is fired.

In this regard, in stacking the green sheets, the green sheet without the first through-holes 11, the second through-holes 12, or the like provided is stacked on the other main surface facing the one main surface of the green sheet with the conductive paste applied thereto. In addition, in pressure-bonding the green sheets, for example, a uniaxial pressing machine can be used. Furthermore, the green sheets are fired, for example, under a temperature condition of 700° C. to 1000° C. in an air atmosphere.

Through the steps S1 to S4 described above, the insulating substrate as illustrated in FIG. 7 is obtained. Here, the insulating substrate is a so-called multiple substrate in which insulating substrates to be finally included respectively in the plurality of capacitors are connected in a matrix, but in FIG. 7, only one of the insulating substrates 10 is focused on, and a peripheral portion thereof is illustrated to be omitted by broken lines.

In the foregoing description, a case in which the first through-holes and the second through-holes are formed in the step S2, and then, the second via conductor is provided in the step S3 has been exemplified; however, only the second through-hole may be formed first, and the first through-hole may be formed after the formation of the second via conductor.

In the foregoing description, a case where the green sheet and the conductive paste are simultaneously fired has been described as an example; however, the second via conductor 14 and the first through-holes 11 may be provided after firing the insulating substrate without the through-hole or the like provided. In that case, the first through-holes 11 and the second through-holes 12 may be provided in the fired insulating substrate by, for example, a sandblasting method, a wet etching method, a dry etching method, or the like, and then, the conductive paste may be applied, and fired. In addition, the second via conductor 14 may be formed by sputtering, vapor deposition, plating, or the like.

Next, as illustrated in FIG. 6, in a step S5, a conductive paste for forming the metal porous body 21 constituting the capacitance forming part 20 is applied.

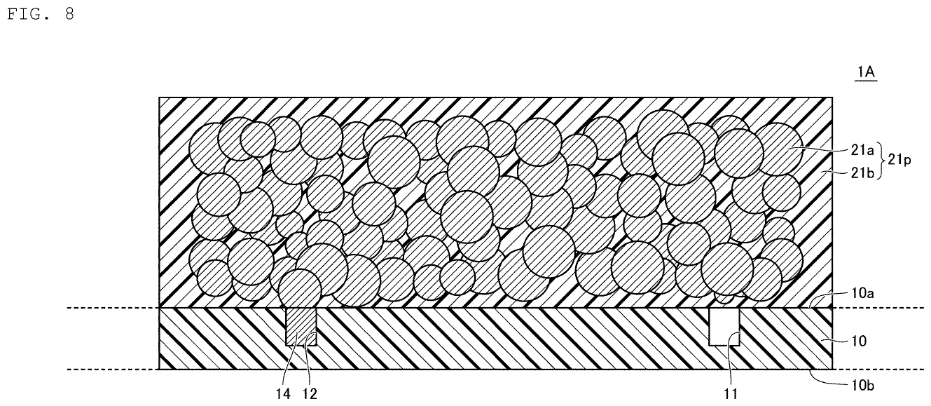

More specifically, as illustrated in FIG. 8, a conductive paste 21p for forming the metal porous body 21 described later is applied onto the first main surface 10a of the insulating substrate 10. After conductive metal particles 21a and a binder 21b including an organic solvent such as terpineol and a varnish of ethyl cellulose are weighed and mixed, the conductive paste 21p is prepared by using a roll machine. The conductive paste 21p thus prepared is applied onto the first main surface 10a of the insulating substrate 10 so as to have a rectangular pattern shape in plan view as a whole, and dried.

At this time, the conductive paste 21p is overapplied multiple times, whereby the conductive paste 21p is applied onto the first main surface 10a so as to form a layer with a predetermined thickness. The conductive paste 21p applied onto the first main surface 10a serve as the metal porous body 21 described above through a firing step, which will be described later. According to the present embodiment, the conductive paste 21p containing the metal particles 21a made of Ni is used.

Here, before the conductive paste 21p is applied, the first through-hole 11 provided in the insulating substrate 10 is preferably provided with a closing portion that closes the first through-hole 11 by applying an epoxy resin or the like (not illustrated). This makes it possible to prevent the conductive paste 21p from entering the inside of the first through-hole 11.

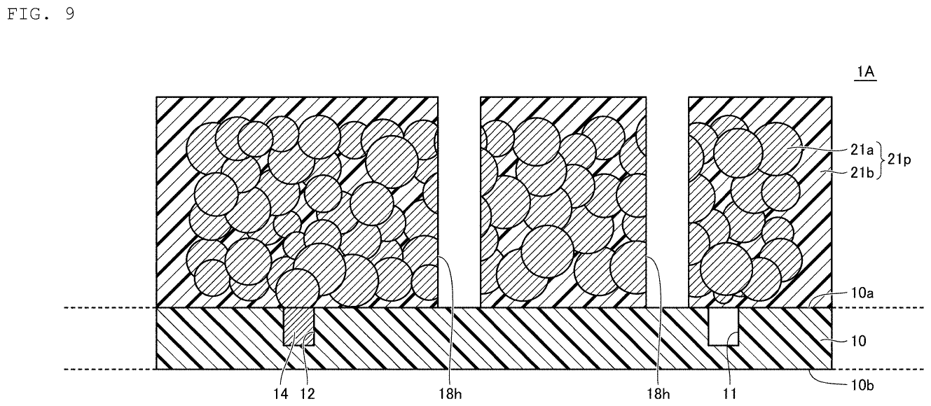

Next, as illustrated in FIG. 6, a partition wall groove is formed in a step S6. More specifically, as illustrated in FIG. 9, a plurality of partition wall grooves 18h extending along a direction (that is, a direction orthogonal to the paper surface in FIG. 9) intersecting a direction connecting the first through-hole 11 and the second via conductor 14 are formed in the conductive paste 21p of a portion located between the first through-hole 11 and the second via conductor 14 when viewed along the normal direction of the first main surface 10a, whereby the conductive paste 21p is partitioned into a plurality of portions. The plurality of partition wall grooves 18h will be filled with the partition wall portion in a step of forming the partition wall portion to be described later.

In the present embodiment, the two partition wall grooves 18h are formed so as to be located side by side from the first through-hole 11 side toward the second via conductor 14 (that is, from the right side to the left side in FIG. 9). As a result, the conductive paste 21p is partitioned into a portion corresponding to the metal porous body 21A described above, a portion corresponding to the metal porous body 21B and the metal porous body 21C, and a portion corresponding to the metal porous body 21D and the metal porous body 21E.

In this regard, the method for forming the partition wall groove 18h is not to be considered particularly limited; however, for example, the partition wall groove 18h can be formed by irradiating the conductive paste 21p with laser light. In addition, the partition wall groove 18h may also be formed by processing with a mechanical puncher used or sandblasting.

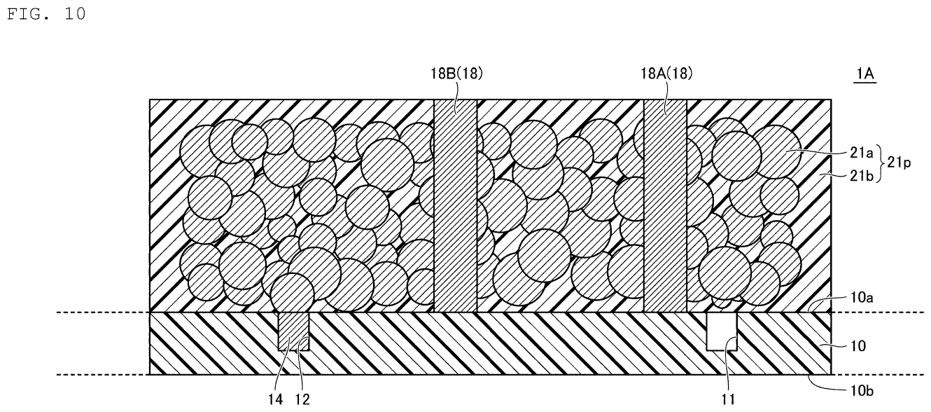

Next, as illustrated in FIG. 6, a partition wall portion is formed in a step S7. More specifically, as illustrated in FIG. 10, the partition wall groove 18h is filled with a conductive paste so as to fill the plurality of partition wall grooves 18h. The two partition wall portions 18 thus formed are erected from the first main surface 10a toward the conductive paste 21p. Of the two partition wall portions 18, one located on the first external connection line side corresponds to the partition wall portion 18A described above, and one located on the second external connection line side with respect to the partition wall portion 18A corresponds to the partition wall portion 18B.

According to the present embodiment, a Ni paste is used as the conductive paste filling the partition wall groove 18h. In the case of such a configuration, the metal wall portion 15 including the same material as the material included in the metal particles 21a (that is, the material included in the metal porous body 21) can be formed, whereby the partition wall portion 18 and the metal porous body 21 will be firmly metal-bonded through the firing step, which will be described later.

In this regard, the method for applying the conductive paste filling the partition wall groove 18h is not to be considered particularly limited; however, for example, an inkjet method can be used.

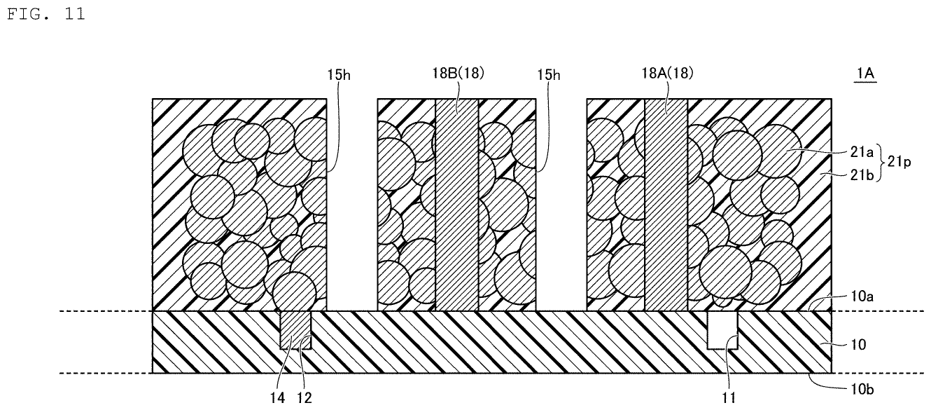

Next, as illustrated in FIG. 6, in a step S8, a metal wall groove is formed. More specifically, as illustrated in FIG. 11, a metal wall groove 15h extending along the direction intersecting the direction connecting the first through-hole 11 and the second via conductor 14 is formed in the conductive paste 21p (that is, the conductive paste 21p of a portion corresponding to the metal porous body 21B and the metal porous body 21C) of a portion located between the partition wall portion 18A and the partition wall portion 18B when viewed along the normal direction of the first main surface 10a, whereby the conductive paste 21p of the above portion is partitioned into a portion corresponding to the metal porous body 21B and a portion corresponding to metal porous body 21C. Similarly, a metal wall groove 15h extending along the direction intersecting the direction connecting the first through-hole 11 and the second via conductor 14 is formed in the conductive paste 21p (that is, the conductive paste 21p of a portion corresponding to the metal porous body 21D and the metal porous body 21E) of a portion located between the partition wall portion 18A and the second via conductor 14 when viewed along the normal direction of the first main surface 10a, whereby the conductive paste 21p of the above portion is partitioned into a portion corresponding to the metal porous body 21D and a portion corresponding to the metal porous body 21E.

The two metal wall grooves 15h will be filled with the metal wall portion in a step of forming the metal wall portion to be described later.

In this regard, the method for forming the metal wall groove 15h is not to be considered particularly limited; however, for example, the metal wall groove 15h can be formed by irradiating the conductive paste 21p with laser light. In addition, the metal wall groove 15h may also be formed by processing with a mechanical puncher used or sandblasting.

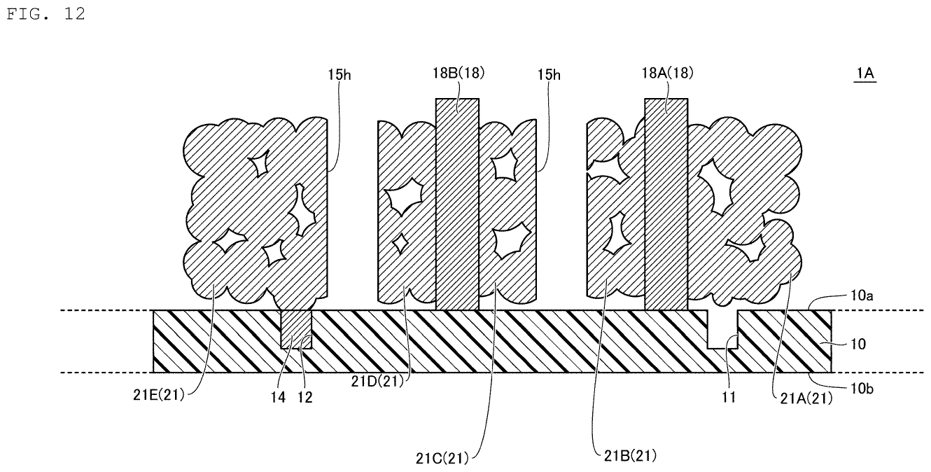

Next, as illustrated in FIG. 6, in a step S9, the conductive paste and the partition wall portion are fired. More specifically, as illustrated in FIG. 12, the conductive paste 21p and the partition wall portion 18 are fired, whereby the adjacent metal particles 21a included in the conductive paste 21p are made sintered and then metal-bonded, and the partition wall portion 18 and the metal particles 21a of a portion adjacent to the partition wall portion 18 are joined. The second via conductor 14 and the metal particles 21a in a portion adjacent to the second via conductor 14 are joined by this firing.

As a result, in the present embodiment, the partition wall portion 18A is joined to the metal porous body 21A and the metal porous body 21B adjacent to the partition wall portion 18A, and the partition wall portion 18B is joined to the metal porous body 21C and the metal porous body 21D adjacent to the partition wall portion 18B. In addition, the second via conductor 14 is joined to the metal porous body 21E adjacent to the second via conductor 14.

At the time of the firing described above, the blocking parts blocking the first through-holes 11, made of, for example, an epoxy resin, are also burned out by the heat.

In performing the firing described above, the insulating substrate 10 is subjected to a degreasing treatment prior to the firing, and thereafter, the above-described conductive paste 21p and partition wall portion 18 are fired, for example, under a temperature condition of 400° C. to 900° C. under a reducing atmosphere in which nitrogen and hydrogen are mixed.

It is to be noted that the atmosphere at the time of the firing is preferably a reducing atmosphere as described above, but can be set to be an atmosphere that is equal to or less than the equilibrium oxygen partial pressure of a metal selected as a main component of the metal particles 21a.

In this regard, as described above, the partition wall portion 18 contains Ni, which is the same material as the material included in the metal particles 21a in the conductive pastes 21p. In the case of such a configuration, the metal particles 21a and the partition wall portion 18 are made sintered and then metal-bonded by the firing described above, and thus, the mechanical strength of the joints between the metal particles 21a and the partition wall portion 18 will be improved.

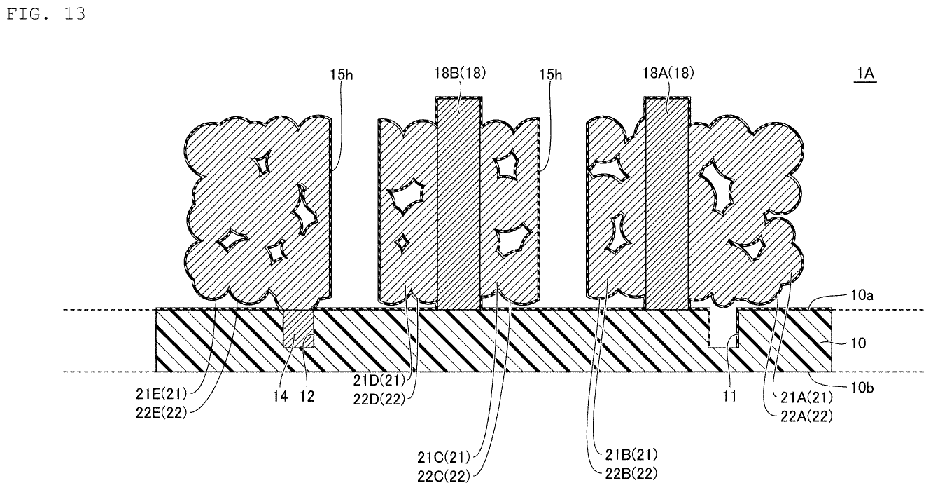

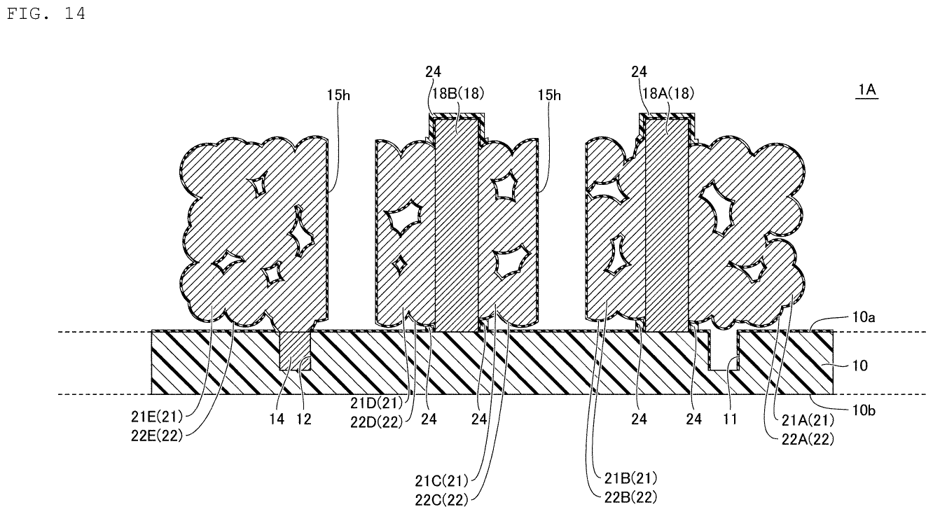

Next, as illustrated in FIG. 6, a dielectric film is formed in a step S10. More specifically, as illustrated in FIG. 13, the dielectric film 22 is formed to cover the surfaces of the first main surface 10a, the metal porous body 21, and the partition wall portion 18 of a portion not joined to the metal porous body 21, and cover the surface of the insulating substrate 10 of a portion that defines the first through-hole 11 provided in the insulating substrate 10.

In this regard, the method for forming the dielectric film 22 is not to be considered particularly limited; however, an ALD method is preferably used. The use of the ALD method allows a raw material for the dielectric film 22 to be supplied as a gas, thus allowing the selection of the material and the adjustment of the film thickness at an atomic layer level. For that reason, also when the fine pores provided inside the metal porous body 21 are extremely small, a homogeneous and dense dielectric film 22 can be formed. In addition, by using the ALD method, the surface of the insulating substrate 10 in the portion defining the first through-hole 11 provided in the insulating substrate 10 can also be easily covered with the dielectric film 22.

In the case of forming the dielectric film 22 by using the ALD method, it is preferable to use, as a raw material gas, a raw material gas that is high in vapor pressure, easily turned into a gas, additionally, high in thermal stability, and high in reactivity such that the raw material gas will spread into the fine pores provided inside the metal porous body 21 and into the first through-hole 11 provided in the insulating substrate 10. From this viewpoint, for example, in the case of forming an AlOₓ film, trimethylaluminum (TMA) is preferably used as a raw material, and in the case of forming an SiOₓ film, trisdimethylaminosilane (TDMAS) is preferably used as the raw material. According to the present embodiment, the dielectric film 22 is formed with the use of the ALD method.

In addition, the dielectric film 22 is formed, for example, under a temperature condition of 150° C. or higher and 400° C. or lower although the conduction differs depending on the film forming method and the film forming material.

Next, as illustrated in FIG. 6, a first resist film is formed in a step S11. More specifically, as illustrated in FIG. 14, a first resist film 24 is formed so as to cover a portion covering the surface of the partition wall portion 18 and a portion in the vicinity thereof in the dielectric film 22 formed in the step S10.

Here, the method of forming the first resist film 24 is not to be considered particularly limited. In the present embodiment, a photosensitive liquid resist is uniformly applied to a predetermined surface of the dielectric film 22 by a spin coating method, and the photosensitive liquid resist is locally exposed using a photomask. Next, the unnecessary photosensitive liquid resist is removed by immersing the photosensitive liquid resist in a developer, and the remaining photosensitive liquid resist is dried in an oven or the like to form the first resist film 24.

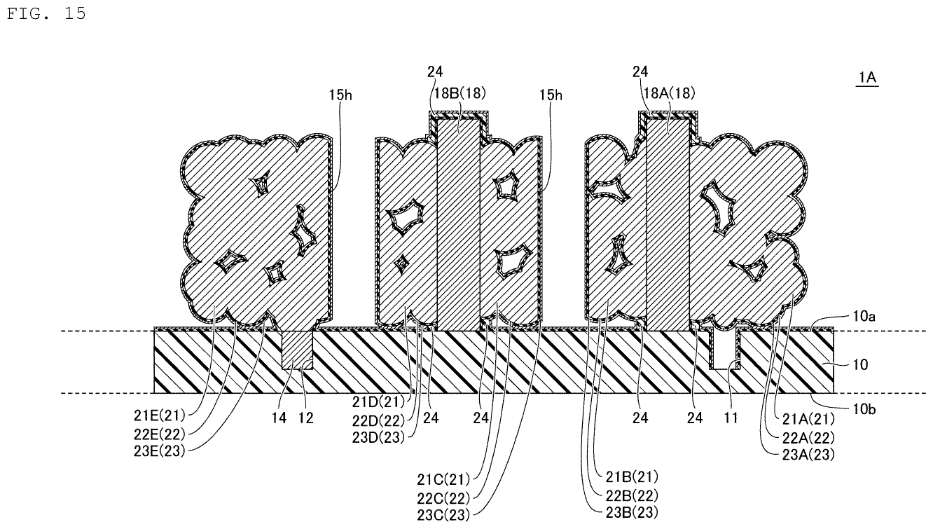

Next, as illustrated in FIG. 6, a conductive film is formed in a step S12. More specifically, as illustrated in FIG. 15, the conductive film 23 is formed so as to cover the dielectric film 22 formed in the step S10 and the first resist film 24 formed in the step S11.

In this regard, the method for forming the conductive film 23 is not to be considered particularly limited as described above, but an ALD method is preferably used. The use of the ALD method allows a raw material for the conductive film 23 to be supplied as a gas, thus allowing the selection of the material and the adjustment of the film thickness at an atomic layer level. For that reason, also when the fine pores provided inside the metal porous body 21 are extremely small, a homogeneous and dense conductive film 23 can be formed. In addition, by using the ALD method, the dielectric film 22 provided inside the first through-hole 11 of the insulating substrate 10 can also be easily covered with the conductive film 23. The conductive film 23 is formed, for example, under a temperature condition of 200° C. or higher and 600 or lower although the conduction differs depending on the film forming method and the film forming material.

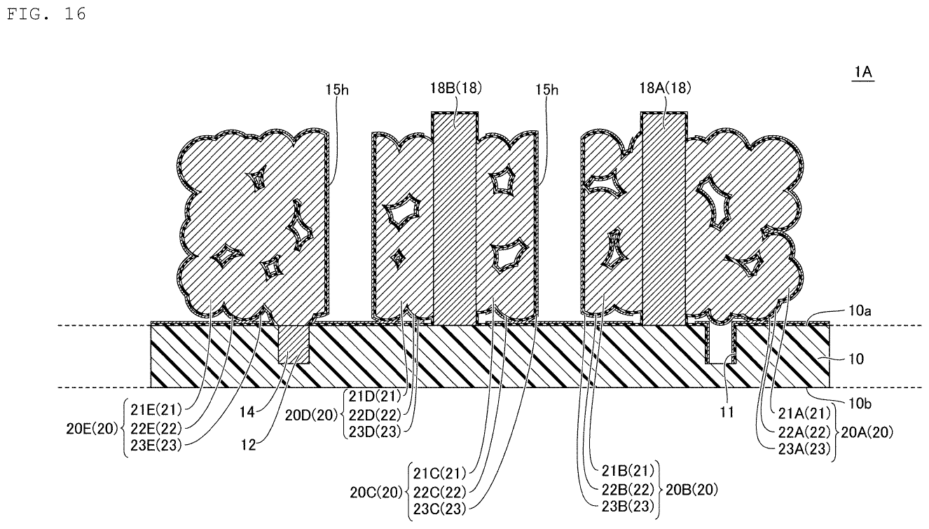

Next, as illustrated in FIG. 6, the first resist film is peeled in a step S13. More specifically, as illustrated in FIG. 16, the first resist film 24 and the conductive film 23 of a portion formed on the surface of the first resist film 24 are peeled by using a peeling solution or the like. By peeling a part of the conductive film 23 in this manner, a discontinuous portion is formed in the conductive film 23 at the part.

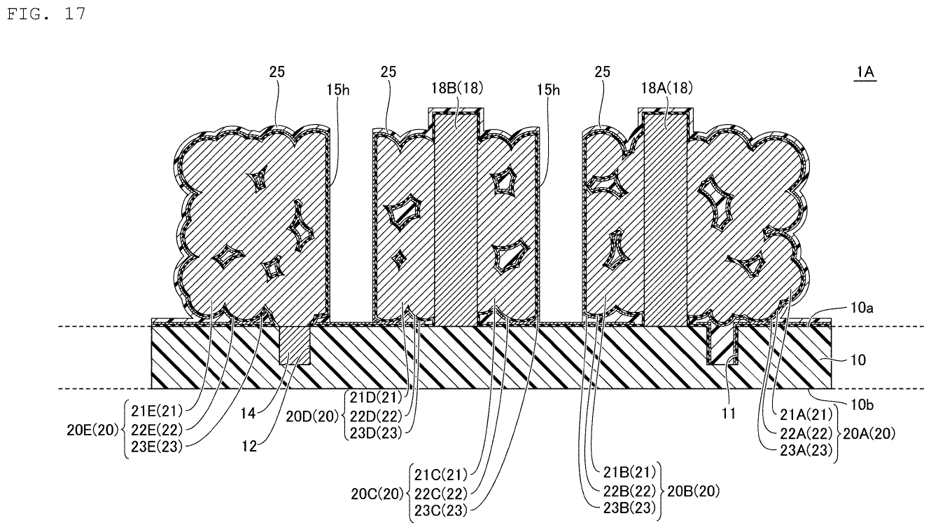

Next, as illustrated in FIG. 6, a second resist film is formed in a step S14. More specifically, as illustrated in FIG. 17, a second resist film 25 is formed so as to cover the dielectric film 22 of a portion exposed to the outside by peeling the first resist film 24 and the conductive film 23 of a portion other than a portion formed at the position corresponding to the plurality of metal wall grooves 15h. The method of forming the second resist film 25 follows the method of forming the first resist film 24 described above.

By forming the second resist film 25 in this manner, it is possible to prevent a substrate constituting the metal wall portion from being unintentionally formed at a portion other than the metal wall groove 15h in a step of forming the metal wall portion to be described later.

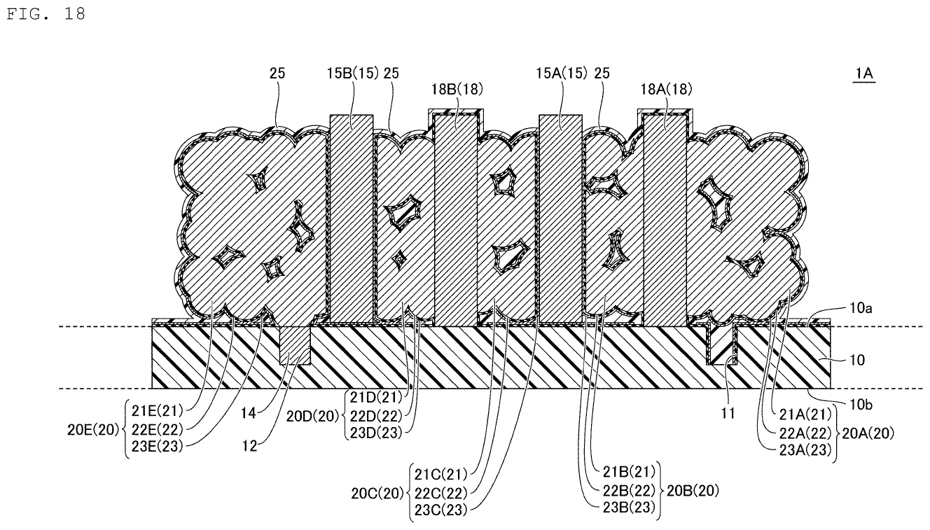

Next, as illustrated in FIG. 6, in a step S15, a metal wall portion is formed. More specifically, as illustrated in FIG. 18, the two metal wall portions 15 are formed so as to fill the two metal wall grooves 15h. The two metal wall portions 15 are erected from the first main surface 10a toward the capacitance forming part 20. Of the two metal wall portions 15, one located on the first external connection line side corresponds to the metal wall portion 15A described above, and one located on the second external connection line side with respect to the metal wall portion 15A corresponds to the metal wall portion 15B.

The metal wall portion 15 formed in this manner is joined to the conductive film 23 of a portion formed at a position corresponding to the metal wall groove 15h. As a result, in the present embodiment, the metal wall portion 15A is joined to the conductive film 23B and the conductive film 23C adjacent to the metal wall portion 15A, and the metal wall portion 15B is joined to the conductive film 23D and the conductive film 23E adjacent to the metal wall portion 15B.

In this regard, the metal wall portion 15 may be formed by a thick film forming method such as electrolytic plating or a screen printing method. According to the present embodiment, the metal wall portion 15 made of Cu is formed by electrolytic plating.

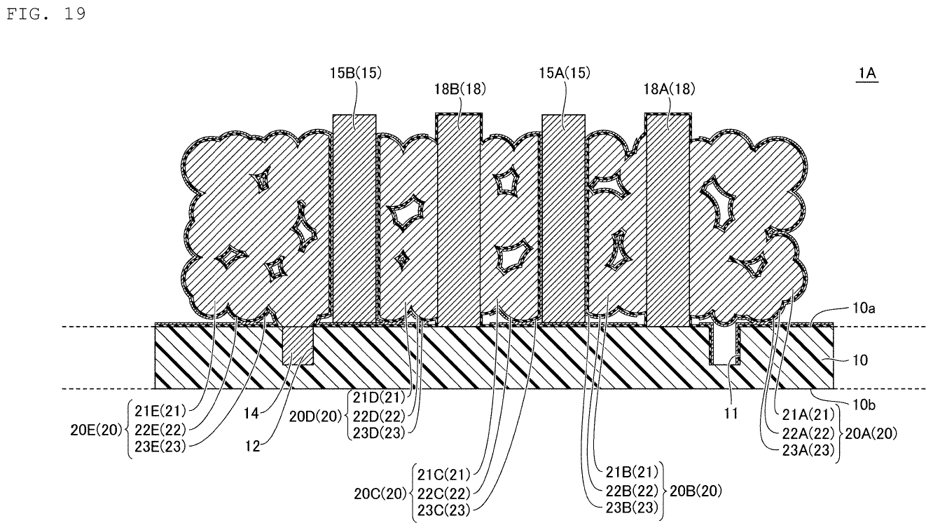

Next, as illustrated in FIG. 6, the second resist film is peeled in a step S16. More specifically, as illustrated in FIG. 19, the second resist film 25 is peeled by using a peeling solution or the like.

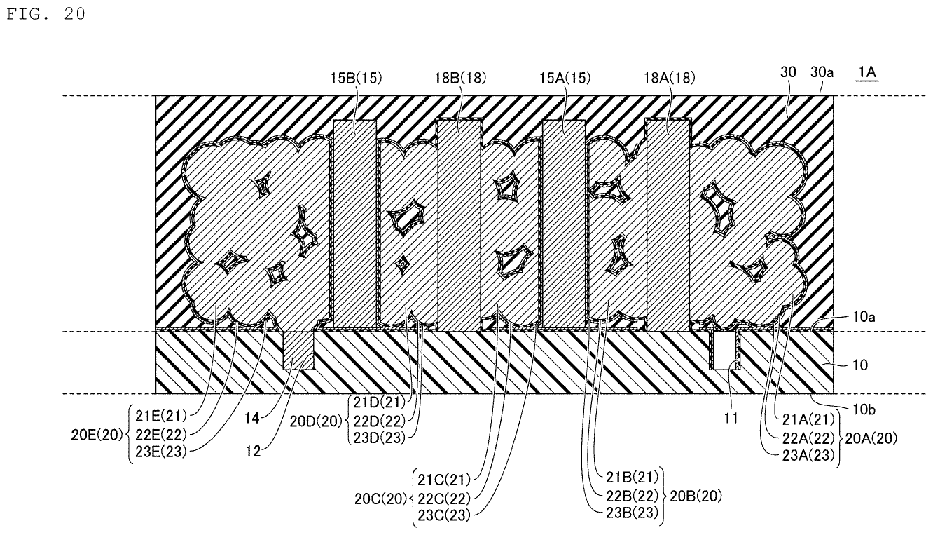

Next, as illustrated in FIG. 6, a sealing part is formed in a step S17. More specifically, as illustrated in FIG. 20, the sealing part 30 is provided on the first main surface 10a of the insulating substrate 10 provided with the capacitance forming part 20 so as to cover the capacitance forming part 20.

The sealing part 30 is formed by, for example, so-called compression molding. More specifically, a resin sheet is put on the first main surface 10a of the insulating substrate 10, and in this state, evacuation is performed with the use of a vacuum laminator to bring the resin sheet into close contact with the first main surface 10a of the insulating substrate 10. Then, in this state, the resin sheet is heated to 50° C. to 100° C. to laminate the capacitance forming part 20, and thereafter, heated to 100° C. to 200° C. to perform main curing, thereby forming the sealing part 30. It is to be noted that the method for forming the sealing part 30 is not limited to the compression molding described above, and may be performed by so-called transfer molding.

Thus, the capacitance forming part 20 is sealed by the insulating substrate 10 and the sealing part 30, and moisture can be prevented from entering the capacitance forming part 20 from the outside, thereby allowing moisture resistance to be secured. In addition, the capacitance forming part 20 is covered with the sealing part 30, and the capacitance forming part 20 is also physically protected by the sealing part 30. It is to be noted that the curing condition mentioned above is merely an example, and various changes can be made to the condition.

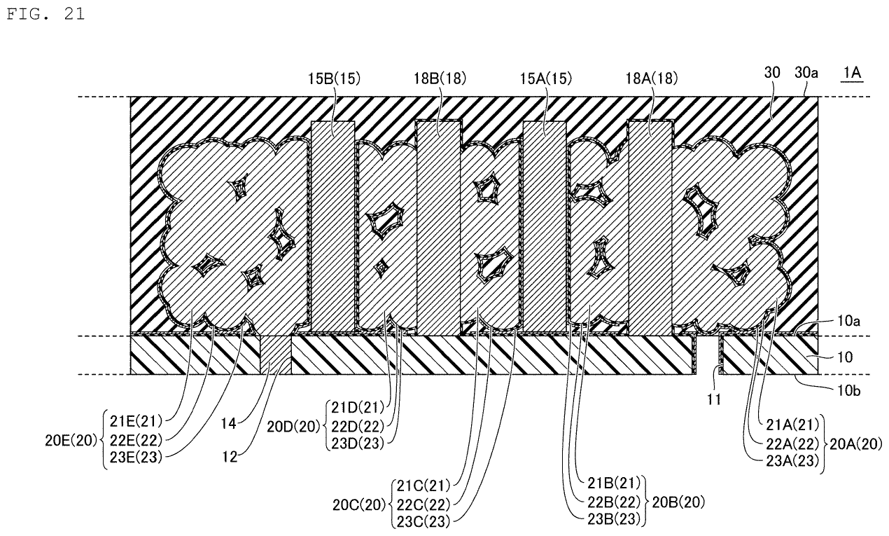

Next, as illustrated in FIG. 6, in a step S18, the insulating substrate is subjected to grinding processing. More specifically, as illustrated in FIG. 21, the second main surface 10b of the insulating substrate 10 located on the side to opposite to the side provided with the capacitance forming part 20 is subjected to plane cutting.

In this regard, for performing the grinding processing, with a grinding tape (not illustrated) attached to the capacitance forming part 20 side, the insulating substrate 10 is removed by plane cutting at a portion that blocks the second via conductor 14 and the first through-hole 11. Thus, an end of the second via conductor 14 is exposed on the second main surface 10b side.

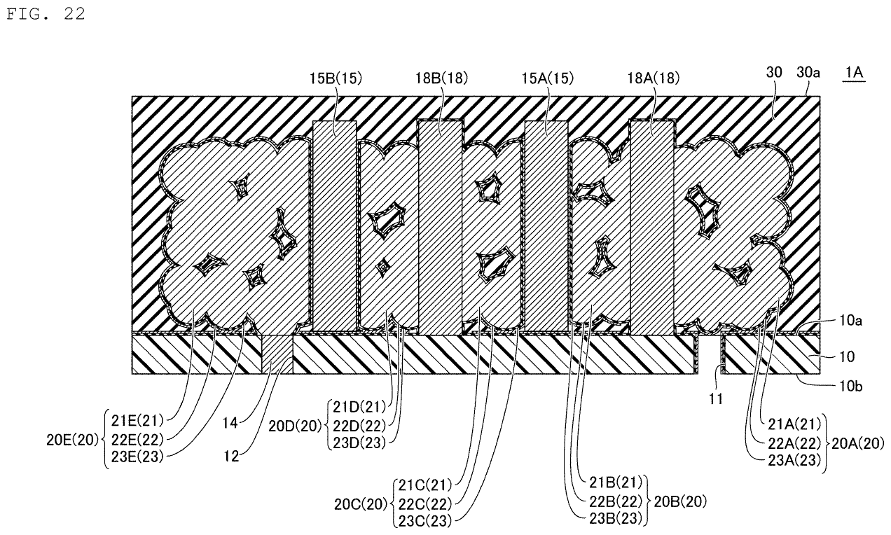

Next, as illustrated in FIG. 6, in a step S19, the insulating substrate is divided into individual pieces. More specifically, as illustrated in FIG. 22, the insulating substrate 10 is divided to divide the plurality of capacitors 1A connected to each other, into individual capacitors.

In this regard, for dividing into the individual capacitors, a groove is formed in at least one of the insulating substrate 10 and sealing part 30, and a force is applied to the insulating substrate 10 and the sealing part 30 so as to bend the insulating substrate 10 and the sealing part 30 from the groove as a starting point, thereby breaking the insulating substrate 10 and the sealing part 30. It is to be noted that diamond scribing, laser scribing, cutting with a dicing machine, or the like can be used as a method for forming the groove. In addition, dividing into the individual capacitors may be performed by directly cutting the insulating substrate 10 and the sealing part 30 by scribing or cutting with a dicing machine.

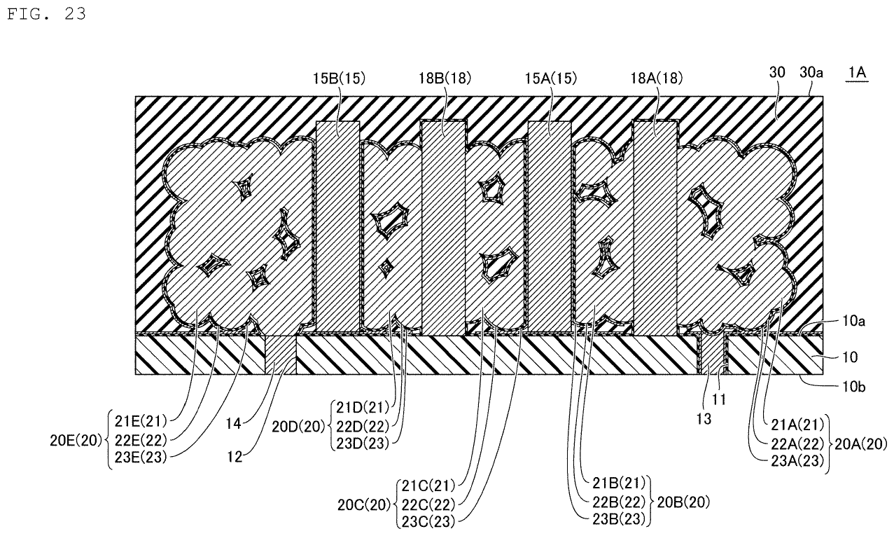

Next, as illustrated in FIG. 6, the first via conductor is formed on the insulating substrate in step S20. More specifically, as illustrated in FIG. 23, the first via conductor 13 is formed so as to fill the first through-hole 11 provided in the insulating substrate 10.

The first via conductor 13 can be formed by, for example, electrolytic plating. In this case, a portion other than the first through-hole 11 is covered with an ultraviolet curable resin film as a mask (not illustrated), and electrolytic plating is performed in this state, so that only the inside of the first through-hole 11 can be covered with a plating film. Note that after completion of the electrolytic plating, the ultraviolet curable resin film as the mask is removed.

The first via conductor 13 formed in this manner is joined to the conductive film 23 on the side surface and an end surface of the first via conductor 13 on the capacitance forming part 20 side (see FIG. 4). Thus, the first via conductor 13 is connected to the capacitance forming part 20 with the conductive film 23 covering the first via conductor 13 interposed therebetween.

Next, as illustrated in FIG. 6, in a step S21, first bumps and second bumps are formed on the insulating substrate. More specifically, as illustrated in FIG. 2, the first bumps 16 and the second bumps 17 are formed on the second main surface 10b of the insulating substrate 10 so as to cover the first via conductors 13 and second via conductors 14 provided in the insulating substrate 10.

The first bumps 16 and the second bumps 17 can be simultaneously formed by, for example, electrolytic plating. In that case, a part excluding the vicinities of the sites where the first via conductors 13 and the second via conductors 14 are exposed is covered with an ultraviolet curable resin film as a mask (not illustrated), and the electrolytic plating is performed in this state, thereby allowing the first bumps 16 and the second bumps 17 to be formed to protrude from the second main surface 10b, and further, after the electrolytic plating is completed, the ultraviolet curable resin film as the mask is removed.

It is to be noted that the method for forming the second via conductors 14, first bumps 16, and second bumps 17 described above is not limited to the method of using the electrolytic plating described above, and a combination of a screen printing method, inkjet method, dispenser method, or the like of using a conductive paste with firing can also be used. In that case, the conductive paste preferably contains a metal or a sintering aid that can be fired at a low temperature such that firing can be performed under a temperature condition that has no influence on the resin constituting the sealing part 30.

Through the steps S1 to S21 described above, the capacitor 1A according to the first embodiment described above, that is, the capacitor in which the capacitance forming part 20A, the capacitance forming part 20B, the capacitance forming part 20C, the capacitance forming part 20D, and the capacitance forming part 20E are electrically connected in series in this order is manufactured.

It is to be noted that, in the method for manufacturing the capacitor 1A according to the present embodiment described above, the sealing part may be formed after performing the grinding processing, while a case where the grinding processing is performed after the sealing part is formed has been exemplified. The grinding processing may be performed after dividing into individual pieces.

Here, in the capacitor 1A according to the present embodiment, as described above, since the conductive film 23 includes the conductive film 23A and the conductive film 23B that are discontinuous with each other, the capacitance forming part 20 is configured to include the capacitance forming part 20A defined by the conductive film 23A, the dielectric film 22A, and the metal porous body 21A, and the capacitance forming part 20B defined by the conductive film 23B, the dielectric film 22B, and the metal porous body 21B. The capacitance forming parts 20B to 20E are electrically connected to the first external connection line with the capacitance forming part 20A interposed therebetween, and the capacitance forming part 20A is electrically connected to the second external connection line with the capacitance forming parts 20B to 20E interposed therebetween, so that the capacitance forming part 20A and the capacitance forming parts 20B to 20E are electrically connected in series between the first external connection line and the second external connection line with the partition wall portion 18A interposed therebetween.

As described above, by providing the portion where the conductive film 23 is discontinuously formed, the capacitance forming part 20 is partitioned into a plurality of sections, and these partitioned capacitance forming parts are electrically connected to each other in series, whereby the withstand voltage of the capacitor 1A can be improved.

That is, when a voltage is applied to a capacitor including a single capacitance forming part to cause electric field concentration in the single capacitance forming part, the function as the capacitor is immediately impaired due to a short circuit.

In this regard, in the capacitor 1A according to the present embodiment, the capacitance forming part 20 is partitioned into a plurality of sections, and these partitioned capacitance forming parts are electrically connected to each other in series. With such a configuration, it is possible to disperse the electric field concentration when a voltage is applied to the capacitor 1A in each of the partitioned capacitance forming parts, so that the withstand voltage of the capacitor 1A can be improved. Thus, it is possible to improve reliability after mounting of the capacitor 1A.

As described above, since the capacitance forming part 20 is partitioned into the plurality of sections and electrically connected in series, when the electric field concentration occurs in a part of the partitioned capacitance forming part 20 and the part is short-circuited (that is, when the voltage is damaged), the electrostatic capacitance corresponding to the capacitance forming part 20 of the remaining portion thereof can be secured as the electrostatic capacitance of the capacitor 1A. Thus, it is possible to obtain the capacitor 1A in which constant electrostatic capacitance is secured after voltage damage and reliability after mounting is improved.

Accordingly, the capacitor 1A according to the present embodiment will improve the reliability after mounting in the capacitor including the capacitance forming part 20 including the metal porous body 21, the dielectric film 22, and the conductive film 23.

The effect of improving the withstand voltage in the capacitor 1A described above has been confirmed by a verification test 1 described later.

In the capacitor 1A according to the present embodiment, the volume of the metal porous body of any one of the capacitance forming parts 20A to 20E may be configured to be smaller than the volume of the metal porous body of the other capacitance forming part adjacent thereto, and the thickness of the dielectric film of the capacitance forming part may be configured to be smaller than the thickness of the dielectric film of the other capacitance forming part. In this case, by reducing the volume of the metal porous body, the electric field concentration can be intentionally easily generated in the capacitance forming part having a small electrostatic capacitance, so that the electrostatic capacitance of the capacitor 1A in a state after voltage damage can be secured to the maximum.

In the case of manufacturing the capacitor 1A in which the thickness of the dielectric film 22 is different for each of the plurality of capacitance forming parts as described above, a resist film is formed so as to cover the dielectric film 22 of a portion other than a portion to be formed thick between the step S10 (that is, formation of the dielectric film) and step S11 (that is, formation of the first resist film) described above, and after the dielectric film 22 is formed again in this state,—the resist film may be peeled.

In addition, in the capacitor 1A according to the present embodiment, as described above, the partition wall portion 18 is joined to a part of the metal porous body 21 of the capacitance forming part 20 in a state of being erected from the first main surface 10a toward the capacitance forming part 20.

With such a configuration, in a case where the insulating substrate 10 is warped by stress generated due to a difference in thermal expansion coefficient between the insulating substrate 10 and the capacitance forming part 20 in the manufacturing process (that is, a firing step, a step of forming a dielectric film, a step of forming a conductive film, and the like) involving the heat treatment of the capacitor 1A, a so-called anchor effect obtained by the partition wall portion 18 can effectively suppress the warpage generated in the insulating substrate 10 and the peeling of the dielectric film 22 and the conductive film 23 from the insulating substrate 10 caused by the warpage of the insulating substrate 10. Thus, mounting stability and post-mounting reliability of the capacitor 1A can be improved.

In the capacitor 1A according to the present embodiment is provided with the plurality of partition wall portions 18 described above. As a result, the warpage occurring in the insulating substrate 10 described above can be further suppressed. The effect of suppressing the warpage occurring in the insulating substrate 10 by providing the partition wall portion 18 has been confirmed by the verification test 2 to be described later.

In addition, in the capacitor 1A according to the present embodiment, as described above, the capacitance forming part 20 is not substantially directly joined to the insulating substrate 10, or if directly joined thereto, is only slightly joined thereto. This also makes it possible to suppress the warpage occurring in the insulating substrate 10 described above.

In the capacitor 1A according to the present embodiment, as described above, the plurality of metal wall portions 15 are joined to a part of the conductive film 23 of the capacitance forming part 20 in a state of being erected from the first main surface 10a toward the capacitance forming part 20. The plurality of metal wall portions 15 can also provide the anchor effect similarly to the partition wall portion 18, so that the warpage occurring in the insulating substrate 10 described above can be suppressed. The effect of suppressing the warpage occurring in the insulating substrate 10 by providing the metal wall portion 15 has been confirmed by a verification test 2 to be described later.

In the capacitor 1A according to the present embodiment, a distance between the partition wall portion 18A and the first via conductor 13 is configured to be shorter than a distance between the partition wall portion 18A and the metal wall portion 15A, whereby the partition wall portion 18A and the metal wall portion 15A are arranged to be separated to an appreciable extent from each other, so that the warpage occurring in the insulating substrate 10 described above can be further suppressed. Similarly, by configuring a distance between the metal wall portion 15B and the second via conductor 14 to be shorter than a distance between the metal wall portion 15B and the partition wall portion 18B, and by arranging the metal wall portion 15B and the partition wall portion 18B to be separated to an appreciable extent from each other, it is possible to further suppress the warpage occurring in the insulating substrate 10 described above.

In addition, in the capacitor 1A according to the present embodiment, as described above, as viewed in the normal direction of the first main surface 10a of the insulating substrate 10, the first via conductors 13 and the second via conductors 14 are both provided in the region where the capacitance forming part 20 is disposed.

In the case of such a configuration, neither the first external connection line nor the second external connection line will be arranged at a position on the side of the capacitance forming part 20, thus making it possible to minimize the sealing part 30 for the part located on the side of the capacitance forming part 20. Thus, not only the capacitor 1A can be configured to be smaller than conventional capacitors, but also the occupied volume of the part excluding the capacitance forming part 20 in the capacitor 1A is reduced to increase the capacitance.

In addition, in the case of the above configuration, since the first via conductor 13 and the second via conductor 14 are positioned to penetrate the insulating substrate 10 in a thickness direction thereof, the via conductors having different polarities are arranged close to each other in a state where current paths thereof face in opposite directions. Thus, the magnetic fields generated on the via conductors by flowing currents act so as to cancel each other, thus allowing the so-called equivalent series inductance (ESL) to be reduced.

In addition, in the capacitor 1A according to the present embodiment, as described above, at the boundary part between the first via conductor 13 and the substrate of the insulating substrate 10, the substrate of the insulating substrate 10 is covered with the dielectric film 22, the dielectric film 22 is covered with the conductive film 23, and the conductive film 23 is further covered with the first via conductor 13.

With such a configuration, the close contact between the substrate of the insulating substrate 10 and the first via conductor 13 is improved as compared with a case where the substrate of the insulating substrate 10 and the first via conductor 13 are directly joined, thus keeping moisture from entering through the part. Accordingly, a capacitor with excellent moisture resistance can be obtained.

In addition, in the capacitor 1A according to the present embodiment, as described above, the metal porous body 21 is made of the sintered body of metal particles. In the case of such a configuration, metal-bonding between the metal particles increases the mechanical strength of the capacitance forming part 20, and also increases the joint area between the metal particles, so that so-called low ESR (equivalent series resistance) can be achieved. Furthermore, the effect of being capable of relatively easily forming the metal porous body with open pores is also achieved.

Here, the capacitor 1A according to the present embodiment may be configured such that when the electrostatic capacitance of any of the capacitance forming parts 20A to 20E is compared with the electrostatic capacitances of the remaining capacitance forming parts, the electrostatic capacitance of the capacitance forming part is 5% to 50% of the electrostatic capacitances of the remaining capacitance forming parts. That is, in the capacitor 1A, the capacitance forming part 20 may be partitioned such that the electrostatic capacitances of the five capacitance forming parts 20A to 20E are uniform to an appreciable extent, and in this case, when a short circuit occurs in any of the capacitance forming parts, a variation in electrostatic capacitance of the capacitor 1A before and after the short circuit can be made comparable.

The capacitor 1A according to the present embodiment may be configured such that the thickness of the dielectric film of any one of the capacitance forming parts 20A to 20E is twice or more the thickness of the dielectric film of another capacitance forming part adjacent thereto. In the case of such a configuration, it is possible to make it difficult to generate the electric field concentration in the capacitance forming part in which the thickness of the dielectric film is configured to be large.

### Second Embodiment

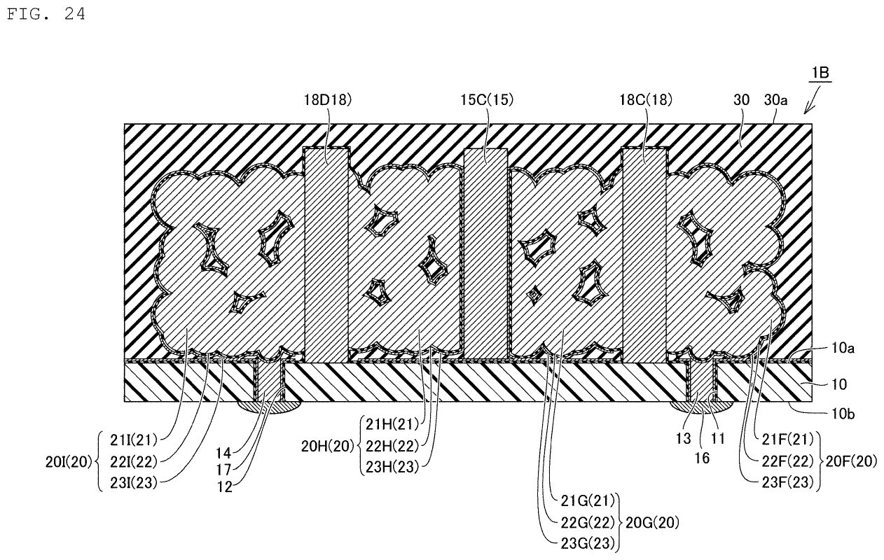

FIG. 24 is a schematic sectional view of a capacitor according to a second embodiment. Hereinafter, a capacitor 1B according to the present embodiment will be described with reference to FIG. 24.

As illustrated in FIG. 24, the capacitor 1B according to the present embodiment is different from the capacitor 1A according to the above-described first embodiment in the number of partitions of the capacitance forming part 20 due to the single metal wall portion 15.

More specifically, in the capacitor 1B according to the present embodiment, the partition wall portion 18C, the metal wall portion 15C, and the partition wall portion 18D are arranged in this order from the first external connection line side toward the second external connection line side (that is, from the right side to the left side in FIG. 24).

As a result, in the present embodiment, the capacitance forming part 20 is divided into four parts. For convenience of description, these four capacitance forming parts are referred to as a capacitance forming part 20F, a capacitance forming part 20G, a capacitance forming part 20H, and a capacitance forming part 20I in order from the closest to the first external connection line. In the present embodiment, the capacitance forming part 20F corresponds to the first capacitance forming part, and the capacitance forming parts 20G to 201 correspond to the second capacitance forming part. The capacitance forming part 20G corresponds to the third capacitance forming part, and the capacitance forming parts 20H and 20I correspond to the fourth capacitance forming part. In addition, the capacitance forming part 20H corresponds to the fifth capacitance forming part, and the capacitance forming part 20I corresponds to the sixth capacitance forming part.

In the present embodiment, the partition wall portion 18C and the partition wall portion 18D correspond to the first partition wall portion and the second partition wall portion, respectively, and the metal wall portion 15C corresponds to the first metal wall portion.

Here, a relationship between the partition wall portion 18C and the capacitance forming parts 20F and 20G is the same as the relationship between the partition wall portion 18A and the capacitance forming parts 20A and 20B in the first embodiment described above. A relationship between the metal wall portion 15C and the capacitance forming parts 20G and 20H is the same as the relationship between the metal wall portion 15A and the capacitance forming parts 20B and 20C in the first embodiment described above. In addition, a relationship between the partition wall portion 18D and the capacitance forming parts 20H and 20I is the same as the relationship between the partition wall portion 18B and the capacitance forming parts 20C and 20D in the first embodiment described above.

In the capacitor 1B, the second via conductor 14 is joined to the conductive film 23 of the capacitance forming part 20. More specifically, the second via conductor 14 is joined to the conductive film 231 of the capacitance forming part 20I.

With the above configuration, in the capacitor 1B according to the present embodiment, the capacitance forming part 20F, the capacitance forming part 20G, the capacitance forming part 20H, and the capacitance forming part 20I are electrically connected in series between the first external connection line and the second external connection line in this order.

Also in the case of such a configuration, the effect that is similar to the effect described in the first embodiment described above will be achieved, and the reliability after mounting will be improved in the capacitor including the capacitance forming part 20 including the metal porous body 21, the dielectric film 22, and the conductive film 23.

The capacitor 1B according to the present embodiment can be manufactured by a method according to the method for manufacturing the capacitor 1A according to the first embodiment described above.

### Third Embodiment

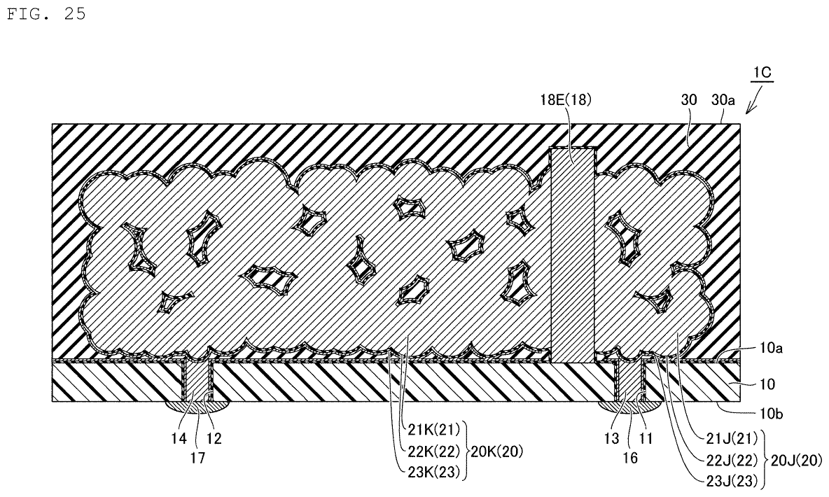

FIG. 25 is a schematic sectional view of a capacitor according to a third embodiment. Hereinafter, a capacitor 1C according to the present embodiment will be described with reference to FIG. 25.

As illustrated in FIG. 25, the capacitor 1C according to the present embodiment is different from the capacitor 1A according to the above-described first embodiment in the number of partitions of the capacitance forming part 20 due to the single partition wall portion 18 and the absence of the metal wall portion 15.

More specifically, in the capacitor 1C according to the present embodiment, when viewed along the normal direction of the first main surface 10a, one partition wall portion 18E is located between the first external connection line and the second external connection line. As a result, in the capacitor 1C, the capacitance forming part 20 is divided into two parts. For convenience of description, these two capacitance forming parts are referred to as a capacitance forming part 20J and a capacitance forming part 20K in order from the closest to the first external connection line. In the present embodiment, the capacitance forming part 20J corresponds to the first capacitance forming part, and the capacitance forming part 20K corresponds to the second capacitance forming part. The partition wall portion 18E corresponds to the first partition wall portion.

Here, a relationship between the partition wall portion 18E and the capacitance forming parts 20J and 20K is the same as the relationship between the partition wall portion 18A and the capacitance forming parts 20A and 20B in the first embodiment described above.

In the capacitor 1C, the second via conductor 14 is joined to the conductive film 23 of the capacitance forming part 20. More specifically, the second via conductor 14 is joined to the conductive film 23K of the capacitance forming part 20K.

With the above configuration, in the capacitor 1C according to the present embodiment, the capacitance forming part 20J and the capacitance forming part 20K are electrically connected in series between the first external connection line and the second external connection line in this order.

Also in the case of such a configuration, the effect that is similar to the effect described in the first embodiment described above will be achieved, and the reliability after mounting will be improved in the capacitor including the capacitance forming part 20 including the metal porous body 21, the dielectric film 22, and the conductive film 23.

The capacitor 1C according to the present embodiment can be manufactured by a manufacturing method excluding steps related to the metal wall portion (that is, the steps S8 and S14 to S16 in FIG. 6) from the method of manufacturing the capacitor 1A according to the first embodiment described above.

### (Verification Test 1)

In the verification test 1, a plurality of types of capacitors having different numbers of metal wall portions and partition wall portions (that is, the number of partitions of the capacitance forming part) were prepared, and the withstand voltage in a case where a voltage was applied to these capacitors was measured to verify an influence of partitioning the capacitance forming part and connecting them in series on the withstand voltage of the capacitor.

In the verification test 1, a total of four types of capacitors including a capacitor in which the capacitance forming part is partitioned into two sections by providing one metal wall portion (hereinafter, for convenience of description, the capacitor is referred to as a two-continuous type), a capacitor in which the capacitance forming part is partitioned into four sections by providing two metal wall portions and one partition wall portion (four-continuous type), a capacitor in which the capacitance forming part is partitioned into six sections by providing three metal wall portions and two partition wall portions (six-continuous type), and a capacitor in which the capacitance forming part is partitioned into eight sections by providing four metal wall portions and three partition wall portions (eight-continuous type), and, as a comparative example, a capacitor in which the capacitance forming part is not partitioned (that is, neither the metal wall portion nor the partition wall portion is provided) were prepared. The four-continuous type capacitor has the same configuration as the capacitor 1B (see FIG. 24) according to the second embodiment described above. In the six-continuous type capacitor and the eight-continuous type capacitor, the metal wall portion and the partition wall portion are alternately arranged from the first external connection line side toward the second external connection line side.

The insulating substrate of the capacitor prepared in the verification test 1 is made of Al₂O₃ and has a size of 1000 μm square and a thickness of 75 μm. The first via conductor and the second via conductor are made of Ni and have a columnar shape with a diameter of 150 μm and an axial length of 75 μm. The distance between the first via conductor 13 and the second via conductor 14 is 150 μm. The first bump 16 and the second bump 17 are made of Au. The metal porous body is made of Ni and has a size of 1000 μm square and a thickness of 200 μm in a state before the capacitance forming part is partitioned. The dielectric film is made of AlSiO, and the conductive film is made of TiN.

The metal wall portion prepared in the verification test 1 is made of Cu, and has a height (dimension in the vertical direction in FIG. 2) of 200 μm, a thickness (dimension in the horizontal direction in FIG. 2) of 70 μm, and a width (dimension in the direction orthogonal to the paper surface in FIG. 2) of 1000 μm. The partition wall portion is made of Ni and has a height of 200 μm, a thickness of 70 μm, and a width of 1000 μm.

The influence of partitioning the capacitance forming part and connecting them in series on the withstand voltage of the capacitor was verified by the method described below using a withstand voltage measuring device (B1500A, manufactured by Keysight Technologies). The number of samples of each type of capacitor described above in the verification was five.

First, both terminals of the capacitor were connected to respective terminals of the withstand voltage measuring device. Next, a voltage was applied to the capacitor under conditions of a current value of 0.05 A and a boosting speed of 0.67 m V/sec. Next, a voltage when the current value was less than 0.05 A was measured as the withstand voltage.

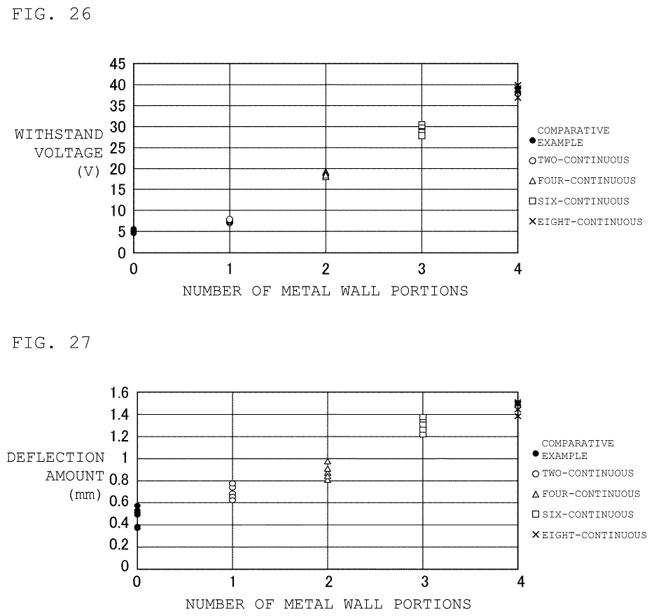

FIG. 26 is a graph showing the results of the verification test 1 performed by the above-described method. The graph shows the withstand voltage of each type of capacitor. As a result of the verification test 1, it has been found that providing the partition wall portion to partition the capacitance forming part and connecting them in series improve the withstand voltage of the capacitor as compared with a case of a single capacitance forming part not partitioned (that is, the case of the comparative example). In addition, it has been found that the effect of improving the withstand voltage of the capacitor becomes more remarkable by increasing the number of capacitance forming parts electrically connected in series (that is, the number of partitions of the capacitance forming part) by increasing the number of metal wall portions and partition wall portions. From the above, it has been found that the withstand voltage of the capacitor is improved by partitioning the capacitance forming part and connecting them in series.

### (Verification Test 2)

In the verification test 2, a plurality of types of capacitors having different numbers (that is, the number of partitions of the capacitance forming part) of metal wall portions and partition wall portions were prepared, and an influence of the metal wall portion and the partition wall portion on a bending strength (mechanical strength) of the capacitor was verified by confirming a deflection amount of the insulating substrate when a load was applied to these capacitors. The type of the capacitor prepared in the verification test 2 is the same as that prepared in the verification test 1 described above.

The influence of the metal wall portion and the partition wall portion on the bending strength of the capacitor was verified by the method described below using a deflection tester (DFT-30, manufactured by Oyo Electric Co., Ltd.). The number of samples of each type of capacitor described above in the verification was five.

First, a glass epoxy substrate having a long side length of 100 mm, a short side length of 40 mm, and a thickness of 1.6 mm was prepared. Next, a solder paste having a thickness of 10 μm was printed on a land of the glass epoxy substrate using a metal mask. Next, a capacitor was mounted on the land on which the solder paste was printed, and these were subjected to heat treatment at 250° C. for 15 minutes.

Next, the glass epoxy substrate on which the capacitor was mounted was set on a mounting table of the deflection tester. Next, a terminal for measuring a capacitor capacitance was brought into contact with the land of the glass epoxy substrate. A measurement frequency of the capacitor capacitance was set to 1 kHz. Next, the glass epoxy substrate was pressed by applying a pressing jig to one of the pair of main surfaces of the glass epoxy substrate on the side where the capacitor was not mounted. As the pressurization conditions, a lifting speed of the pressing jig was 0.1 mm/see, and the load was 0.003 N.

Next, the deflection amount of the capacitor when the capacitor capacitance became 10% or less of the capacitor capacitance in the state before pressurization (that is, when the capacitor is short-circuited) by this pressurization was measured. The deflection amount means a displacement amount (that is, the displacement amount along the vertical direction in FIG. 2) from an initial position along the normal direction of the first main surface of the insulating substrate in a portion located at the center of the insulating substrate in plan view.

FIG. 27 is a graph showing the results of the verification test 2 performed by the above-described method. The graph shows the deflection amount of each type of capacitor. As a result of the verification test 2, it has been found that since the partition wall portion is provided on the insulating substrate, the deflection amount of the insulating substrate is increased as compared with the case where the partition wall portion is not provided (that is, in the case of the comparative example). Furthermore, it has been found that the effect of increasing the deflection amount becomes more remarkable by increasing the number of metal wall portions and partition wall portions. As described above, when the external force is applied to the capacitor, the deflection amount when the capacitor is short-circuited increases, and therefore, it has been found that the bending strength of the capacitor is improved by providing the metal wall portion and the partition wall portion.

### (Supplement)

The characteristic configuration of the capacitor disclosed in the above-described embodiment is summarized as follows.

### [Supplement 1]

A capacitor including: an insulating substrate having a first main surface and a second main surface opposite to the first main surface; a first capacitance forming part facing the first main surface, the first capacitance forming part including: a first metal porous body having conductivity; a first dielectric film covering a surface of the first metal porous body; and a first conductive film covering the first dielectric film; and a second capacitance forming part facing the first main surface, the second capacitance forming part including: a second metal porous body having conductivity; a second dielectric film covering a surface of the second metal porous body; and a second conductive film covering the second dielectric film, wherein the first conductive film and the second conductive film are discontinuous with each other; a first external connection line; and a second external connection line, wherein the second capacitance forming part is located on a side opposite to the first external connection line as viewed from the first capacitance forming part, the second capacitance forming part is electrically connected to the first external connection line with the first capacitance forming part interposed therebetween, and when the first capacitance forming part is electrically connected to the second external connection line with the second capacitance forming part interposed therebetween, at least the first capacitance forming part and the second capacitance forming part are electrically connected in series between the first external connection line and the second external connection line.

### [Supplement 2]

The capacitor according to Supplement 1, further including a metal first partition wall portion that partitions the first metal porous body and the second metal porous body, partitions the first dielectric film and the second dielectric film, and partitions the first conductive film and the second conductive film, wherein when the first partition wall portion is joined to the first metal porous body and the second metal porous body, and not joined to the first conductive film and the second conductive film, at least the first capacitance forming part and the second capacitance forming part are electrically connected in series with the first partition wall portion interposed therebetween between the first external connection line and the second external connection line.

### [Supplement 3]

The capacitor according to Supplement 2, wherein the first partition wall portion is erected from the first main surface.

### [Supplement 4]

The capacitor according to Supplement 2 or 3, wherein the first partition wall portion has a thickness of 5 μm or more.

### [Supplement 5]

The capacitor according to Supplement 4, wherein the first partition wall portion has a thickness of 75 μm or less.

### [Supplement 6]

The capacitor according to any one of Supplements 2 to 5, wherein a height of the first partition wall portion in a direction parallel to a normal direction of the first main surface is larger than a height of the capacitance forming part in the direction parallel to the normal direction of the first main surface.

### [Supplement 7]

The capacitor according to any one of Supplements 2 to 6, wherein a width of the first partition wall portion in a direction intersecting both a thickness direction and a height direction of the first partition wall portion is larger than a width of at least one of the first capacitance forming part or the second capacitance forming part in the direction intersecting both the thickness direction and the height direction of the first partition wall portion.

### [Supplement 8]

The capacitor according to any one of Supplements 1 to 7, wherein a thickness of the first dielectric film is twice or more a thickness of the second dielectric film, or the thickness of the second dielectric film is twice or more the thickness of the first dielectric film.

### [Supplement 9]

The capacitor according to any one of Supplements 1 to 7, wherein an electrostatic capacitance of the first capacitance forming part is 5% to 50% of an electrostatic capacitance of the second capacitance forming part.

### [Supplement 10]

The capacitor according to any one of Supplements 1 to 9, wherein the first external connection line includes a first via conductor penetrating the insulating substrate so as to reach from the first main surface to the second main surface, the second external connection line includes a second via conductor penetrating the insulating substrate so as to reach from the first main surface to the second main surface, the first via conductor is in a region where the first capacitance forming part is disposed when viewed along the normal direction of the first main surface, and the second via conductor is in a region where the second capacitance forming part is disposed when viewed along the normal direction of the first main surface.

### [Supplement 11]

The capacitor according to any one of Supplements 1 to 10, further including a first metal wall portion that partitions the second capacitance forming part such that the second capacitance forming part includes a third capacitance forming part located on the side of the first external connection line and a fourth capacitance forming part located on the side of the second external connection line with respect to the third capacitance forming part, wherein the third capacitance forming part includes a third metal porous body that is the second metal porous body of a portion that defines the third capacitance forming part, a third dielectric film that is the second dielectric film of a portion corresponding to the third metal porous body, and a third conductive film that is the second conductive film of a portion corresponding to the third dielectric film, the fourth capacitance forming part includes a fourth metal porous body that is the second metal porous body of a portion that defines the fourth capacitance forming part, a fourth dielectric film that is the second dielectric film of a portion corresponding to the fourth metal porous body, and a fourth conductive film that is the second conductive film of a portion corresponding to the fourth dielectric film, when the first metal wall portion is jointed to the third conductive film and the fourth conductive film, the fourth capacitance forming part is electrically connected to the first external connection line with the third capacitance forming part interposed therebetween, and when the third capacitance forming part is electrically connected to the second external connection line with the fourth capacitance forming part interposed therebetween, at least the third capacitance forming part and the fourth capacitance forming part are electrically connected in series between the first external connection line and the second external connection line.

### [Supplement 12]

The capacitor according to Supplement 11, wherein when the fourth conductive film includes a fifth conductive film and a sixth conductive film that are discontinuous with each other, the fourth capacitance forming part includes a fifth capacitance forming part defined by the fifth conductive film, a fifth dielectric film that is the fourth dielectric film of a portion corresponding to the fifth conductive film, and a fifth metal porous body that is the fourth metal porous body of a portion corresponding to the fifth dielectric film, and a sixth capacitance forming part defined by the sixth conductive film, a sixth dielectric film that is the fourth dielectric film of a portion corresponding to the sixth conductive film, and a sixth metal porous body that is the fourth metal porous body of a portion corresponding to the sixth dielectric film, the sixth capacitance forming part is located on the side opposite to the first external connection line side as viewed from the fifth capacitance forming part, and when the sixth capacitance forming part is electrically connected to the first external connection line with the fifth capacitance forming part interposed therebetween, and the fifth capacitance forming part is electrically connected to the second external connection line with the sixth capacitance forming part interposed therebetween, at least the fifth capacitance forming part and the sixth capacitance forming part are electrically connected in series between the first external connection line and the second external connection line.

### [Supplement 13]

The capacitor according to Supplement 12, further including a metal second partition wall portion that partitions the fourth metal porous body into the fifth metal porous body and the sixth metal porous body, partitions the fourth dielectric film into the fifth dielectric film and the sixth dielectric film, and partitions the fourth conductive film into the fifth conductive film and the sixth conductive film, wherein when the second partition wall portion is joined to the fifth metal porous body and the sixth metal porous body, and not joined to the fifth conductive film and the sixth conductive film, at least the fifth capacitance forming part and the sixth capacitance forming part are electrically connected in series with the second partition wall portion interposed therebetween between the first external connection line and the second external connection line.

### [Supplement 14]

The capacitor according to Supplement 12 or 13, further including a second metal wall portion that partitions the sixth capacitance forming part such that the sixth capacitance forming part includes a seventh capacitance forming part located on the side of the first external connection line and an eighth capacitance forming part located on the side of the second external connection line with respect to the seventh capacitance forming part, wherein the seventh capacitance forming part includes a seventh metal porous body that is the sixth metal porous body of a portion that defines the seventh capacitance forming part, a seventh dielectric film that is the sixth dielectric film of a portion corresponding to the seventh metal porous body, and a seventh conductive film that is the sixth conductive film of a portion corresponding to the seventh dielectric film, the eighth capacitance forming part includes an eighth metal porous body that is the sixth metal porous body of a portion that defines the eighth capacitance forming part, an eighth dielectric film that is the sixth dielectric film of a portion corresponding to the eighth metal porous body, and an eighth conductive film that is the sixth conductive film of a portion corresponding to the eighth dielectric film, and when the second metal wall portion is jointed to the seventh conductive film and the eighth conductive film, the eighth capacitance forming part is electrically connected to the first external connection line with the seventh capacitance forming part interposed therebetween, and when the seventh capacitance forming part is electrically connected to the second external connection line with the eighth capacitance forming part interposed therebetween, at least the seventh capacitance forming part and the eighth capacitance forming part are electrically connected in series between the first external connection line and the second external connection line.

### (Other Modes, etc.)

The shape, configuration, size, number, material, and the like of each of the parts described in the above-described embodiments of the present description can be variously changed without departing from the scope of the present description.

In addition, the characteristic configurations described in the above-mentioned embodiments of the present description can be naturally combined with each other within an allowable range in light of the scope of the present description.

As described above, the above embodiment disclosed this time is illustrative in all points and not restrictive. The technical scope of the present description is defined by the claims, and considered including all modifications within the meaning and scope equivalent to the description of the claims.

### DESCRIPTION OF REFERENCE SYMBOLS

1A to 1C: Capacitor
10: Insulating substrate
10a: First main surface
10b: Second main surface
11: First through-hole
12: Second through-hole
13: First via conductor
14: Second via conductor
15, 15A to 15C: Metal wall portion
15h: Metal wall groove
16: First bump
17: Second bump
18, 18A to 18E: Partition wall portion
18h: Partition wall groove
20, 20A to 20K: Capacitance forming part
21, 21A to 21K: Metal porous body
21a: Metal particle
21b: Binder
21p: Conductive paste
22, 22A to 22K: Dielectric film
23, 23A to 23K: Conductive film
24: First resist film
25: Second resist film
30: Sealing part
30a: Outer surface

1. A capacitor comprising:
an insulating substrate having a first main surface and a second main surface opposite to the first main surface;
a first capacitance forming part facing the first main surface, the first capacitance forming part including: a first metal porous body having conductivity; a first dielectric film covering a surface of the first metal porous body; and a first conductive film covering the first dielectric film; and
a second capacitance forming part facing the first main surface, the second capacitance forming part including: a second metal porous body having conductivity; a second dielectric film covering a surface of the second metal porous body; and a second conductive film covering the second dielectric film, wherein the first conductive film and the second conductive film are discontinuous with each other;
a first external connection line; and
a second external connection line,
wherein
the second capacitance forming part is located on a side opposite to the first external connection line as viewed from the first capacitance forming part,
the second capacitance forming part is electrically connected to the first external connection line with the first capacitance forming part interposed therebetween, and when the first capacitance forming part is electrically connected to the second external connection line with the second capacitance forming part interposed therebetween, at least the first capacitance forming part and the second capacitance forming part are electrically connected in series between the first external connection line and the second external connection line.

2. The capacitor according to claim 1, further comprising:
a metal first partition wall portion that partitions the first metal porous body and the second metal porous body, partitions the first dielectric film and the second dielectric film, and partitions the first conductive film and the second conductive film,
wherein when the first partition wall portion is joined to the first metal porous body and the second metal porous body, and not joined to the first conductive film and the second conductive film, at least the first capacitance forming part and the second capacitance forming part are electrically connected in series with the first partition wall portion interposed therebetween between the first external connection line and the second external connection line.

3. The capacitor according to claim 2, wherein the metal first partition wall portion extends from the first main surface.

4. The capacitor according to claim 2, wherein the metal first partition wall portion has a thickness of 5 μm or more.

5. The capacitor according to claim 4, wherein the metal first partition wall portion has a thickness of 75 μm or less.

6. The capacitor according to claim 2, wherein a height of the metal first partition wall portion in a direction parallel to a normal direction of the first main surface is larger than a height of the capacitance forming part in the direction parallel to the normal direction of the first main surface.

7. The capacitor according to claim 2, wherein a width of the metal first partition wall portion in a direction intersecting both a thickness direction and a height direction of the metal first partition wall portion is larger than a width of at least one of the first capacitance forming part or the second capacitance forming part in the direction intersecting both the thickness direction and the height direction of the metal first partition wall portion.

8. The capacitor according to claim 1, wherein a thickness of the first dielectric film is twice or more a thickness of the second dielectric film.

9. The capacitor according to claim 1, wherein a thickness of the second dielectric film is twice or more a thickness of the first dielectric film.

10. The capacitor according to claim 1, wherein an electrostatic capacitance of the first capacitance forming part is 5% to 50% of an electrostatic capacitance of the second capacitance forming part.

11. The capacitor according to claim 1, wherein
the first external connection line includes a first via conductor penetrating the insulating substrate so as to reach from the first main surface to the second main surface,
the second external connection line includes a second via conductor penetrating the insulating substrate so as to reach from the first main surface to the second main surface,
the first via conductor is in a region where the first capacitance forming part is disposed when viewed along the normal direction of the first main surface, and
the second via conductor is in a region where the second capacitance forming part is disposed when viewed along the normal direction of the first main surface.

12. The capacitor according to claim 2, further comprising:
a second partition wall portion that partitions the first metal porous body, and partitions the first conductive film and the second conductive film,
wherein when the second partition wall portion is covered by the first dielectric film at a portion of the second partition wall portion not joined to the first metal porous body.
